(19) United States
(12) Patent Application Publication
(10) Pub. No.: US 2025/0131485 A1
(43) Pub. Date: Apr. 24, 2025

(54) COMPUTERIZED SYSTEMS AND METHODS FOR GENERATING CUSTOMIZABLE LANDING WEBPAGES

(71) Applicant: Coupang Corp, Seoul (KR)

(72) Inventors: Vinay VERMA, Fremont, CA (US); Hyun Jung CHO, Seoul (KR); Erik Axel THOERNBLAD, Seoul (KR); Xiaowei LIU, Beijing (CN); Tejas PATHAK, San Jose, CA (US); SatyaVaraPrasad VADLAMUDI, Santa Clara, CA (US); Karthik Reddy DONDAPATI, San Jose, CA (US); Zenglin XU, Shanghai (CN); Hao ZUO, Shanghai (CN); Jing LI, Shanghai (CN)

(21) Appl. No.: 18/382,103

(22) Filed: Oct. 20, 2023

(51) Int. Cl. G06Q 30/0601; G06Q 30/0207

(52) U.S. Cl. CPC G06Q 30/0631; G06Q 30/0207; G06Q 30/0643

(57) ABSTRACT

Systems and methods for generating customizable landing webpages. Methods include receiving input from a vendor user device; receiving, from a customer user device, at least one user engagement associated with a plurality of products; receiving configuration data from the vendor user device; and generating a landing webpage by: generating a webpage; applying the configuration data to the plurality of products associated with the at least one user engagement; determining at least one recommended product based on the applied configuration data; generating at least one user interface icon corresponding to the at least one recommended product; inserting the at least one user interface icon into at least one widget zone of a webpage layout structure; and upon a customer user interaction with the generated landing webpage, generating a single detail page corresponding to the at least one recommended product.

### TECHNICAL FIELD

The present disclosure generally relates to computerized systems and methods for generating customizable landing webpages. In particular, embodiments of the present disclosure relate to inventive and unconventional systems for users, including vendors or marketers, to flexibly generate customizable landing webpages for customers, where the landing webpages include recommendations of products that are personalized for each customer.

### BACKGROUND

Landing webpages are webpages that are generated for particular promotion events (e.g., a holiday, a coupon for products during a time period, a discount for certain products, etc.). Landing webpages may be generated on a customer user's homepage or may be generated when a customer user selects a user interface icon on a user interface on a homepage. Vendors (e.g., marketers) often rely on landing webpages to market and sell products to customers. In some cases, vendors using landing webpages to market products during campaigns, where certain products are discounted or have an associated coupon during a campaign time period.

Typical landing webpages, however, suffer from constraints. For example, typical landing webpages market the same products for all customers and are not personalized for each customer. This constraint poses a problem to customers because customers want to see products relevant to them on their landing webpages and are more likely to purchase relevant products. Moreover, it is difficult for customers to search for relevant products when there are many thousands of products to choose.

Additionally, vendors may not have the education or experience to create landing webpages.

Therefore, there is a need for improved methods and systems for generating landing webpages that result in increased purchases of products by customers.

### SUMMARY

One aspect of the present disclosure is directed to a computer-implemented system for generating customizable landing webpages, the system comprising: a memory storing instructions; and at least one processor configured to execute the instructions to: receive input from a vendor user device to generate a data structure, the data structure comprising a webpage layout structure including at least one widget zone for insertion of a user interface icon; receive, from a customer user device, at least one user engagement associated with a plurality of products; receive configuration data from the vendor user device, the configuration data comprising a model, at least one targeted customer, and a time span; and generate a landing webpage by: generating a webpage using the data structure; applying the configuration data to the plurality of products associated with the at least one user engagement; determining at least one recommended product of the plurality of products based on the applied configuration data; generating at least one user interface icon corresponding to the at least one recommended product; inserting the at least one user interface icon into the at least one widget zone of the webpage layout structure; and upon a customer user interaction with the generated landing webpage, generating a single detail page corresponding to the at least one recommended product.

Another aspect of the present disclosure is directed to a computer-implemented method for generating customizable landing webpages, comprising: receiving input from a vendor user device to generate a data structure, the data structure comprising a webpage layout structure including at least one widget zone for insertion of a user interface icon; receiving, from a customer user device, at least one user engagement associated with a plurality of products; receiving configuration data from the vendor user device, the configuration data comprising a model, at least one targeted customer, and a time; and generating a landing webpage by: generating a webpage using the data structure; applying the configuration data to the plurality of products associated with the at least one user engagement; determining at least one recommended product of the plurality of products based on the applied configuration data; generating at least one user interface icon corresponding to the at least one recommended product; inserting the at least one user interface icon into the at least one widget zone of the webpage layout structure; and upon a customer user interaction with the generated landing webpage, generating a single detail page corresponding to the at least one recommended product.

Yet another aspect of the present disclosure is directed to computer-implemented system for generating customizable landing webpages, the system comprising: a memory storing instructions; and at least one processor configured to execute the instructions to: receive input from a vendor user device to generate a data structure, the data structure comprising a webpage layout structure including at least one widget zone for insertion of a user interface icon; receive, from a customer user device, at least one user engagement associated with a plurality of products; receive configuration data from the vendor user device, the configuration data comprising a model, at least one targeted customer, and a time span; and generate a landing webpage by: generating a webpage using the data structure; applying the configuration data to the plurality of products associated with the at least one user engagement; generating a hierarchical data structure of the plurality of products based on the applied configuration data; determining, using the generated hierarchical data structure, at least one recommended product; generating at least one user interface icon corresponding to the at least one recommended product; inserting the at least one user interface icon into the at least one widget zone of the webpage layout structure; and upon a customer user interaction with the generated landing webpage, generating a single detail page corresponding to the at least one recommended product.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a schematic block diagram illustrating an exemplary embodiment of a content management system to generate landing webpages, consistent with the disclosed embodiments.

FIG. 4 is a schematic block diagram illustrating an exemplary embodiment of a content management system to generate landing webpages, consistent with the disclosed embodiments.

FIG. 5 is a schematic block diagram illustrating an exemplary embodiment of a content management system to generate landing webpages, consistent with the disclosed embodiments.

FIG. 6 is an exemplary user interface of a campaign manager, consistent with the disclosed embodiments.

FIG. 7 is an exemplary user interface of an audience platform, consistent with the disclosed embodiments.

FIG. 8 is an exemplary personalized landing webpage for a customer, consistent with the disclosed embodiments.

FIGS. 9A-9F show exemplary user interfaces for generating personalized landing webpages, consistent with the disclosed embodiments.

FIGS. 10A and 10B show a comparison between control landing webpages and landing webpages generated as described in disclosed embodiments, consistent with the disclosed embodiments.

FIGS. 11A and 11B show a comparison between control landing webpages and landing webpages generated as described in disclosed embodiments, consistent with the disclosed embodiments.

FIG. 12 is a diagram of a process for generating customizable landing webpages, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for generating customizable landing webpages. In some embodiments, a system may include a memory storing instructions; and at least one processor configured to execute the instructions to: receive input from a vendor user device to generate a data structure, the data structure comprising a webpage layout structure including at least one widget zone for insertion of a user interface icon; receive, from a customer user device, at least one user engagement associated with a plurality of products; receive configuration data from the vendor user device, the configuration data comprising a model, at least one targeted customer, and a time span; and generate a landing webpage by: generating a webpage using the data structure; applying the configuration data to the plurality of products associated with the at least one user engagement; determining at least one recommended product of the plurality of products based on the applied configuration data; generating at least one user interface icon corresponding to the at least one recommended product; inserting the at least one user interface icon into the at least one widget zone of the webpage layout structure; and upon a customer user interaction with the generated landing webpage, generating a single detail page corresponding to the at least one recommended product.

Advantageously, vendors may use the disclosed embodiments to generate personalized landing webpages that may scale without any engineering. Moreover, the disclosed embodiments provide the capability to vendors to personalize customers' experience with landing webpages by providing product recommendations that customers are more likely to engage with and purchase.

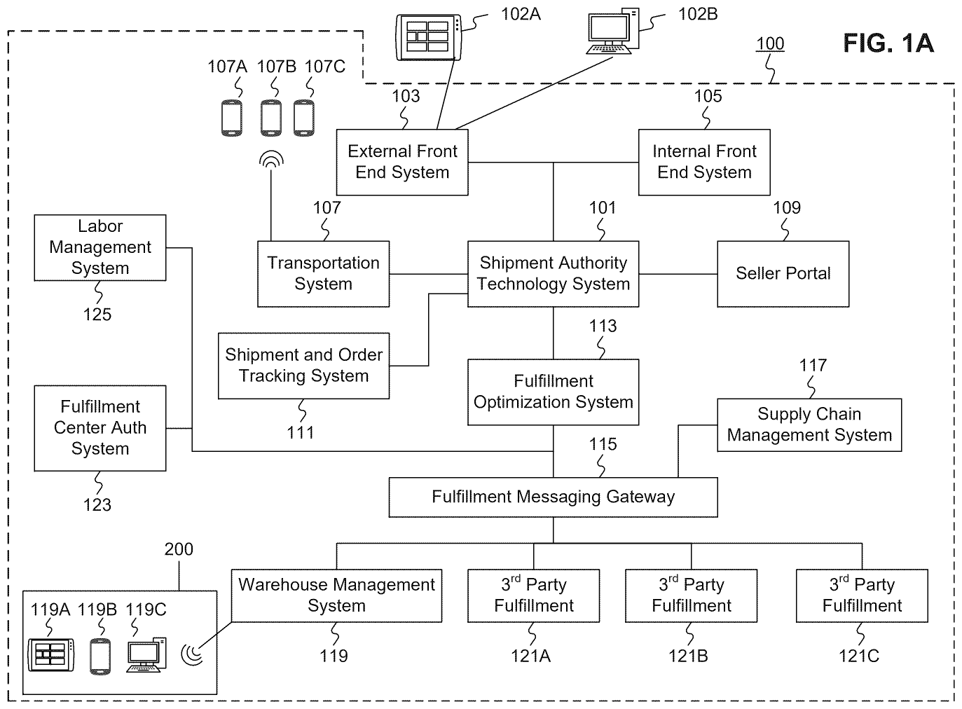

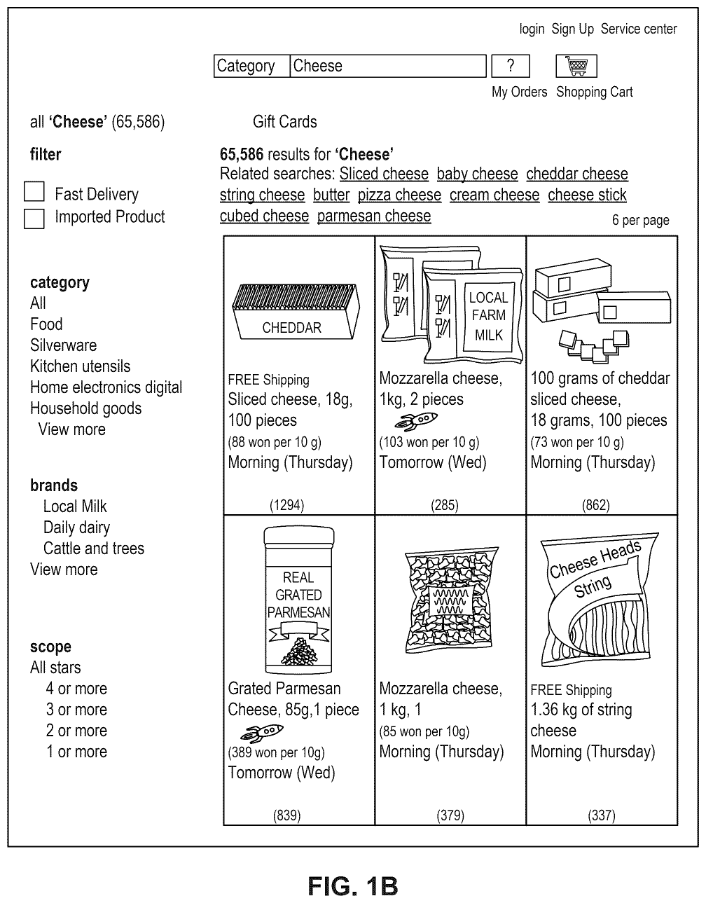

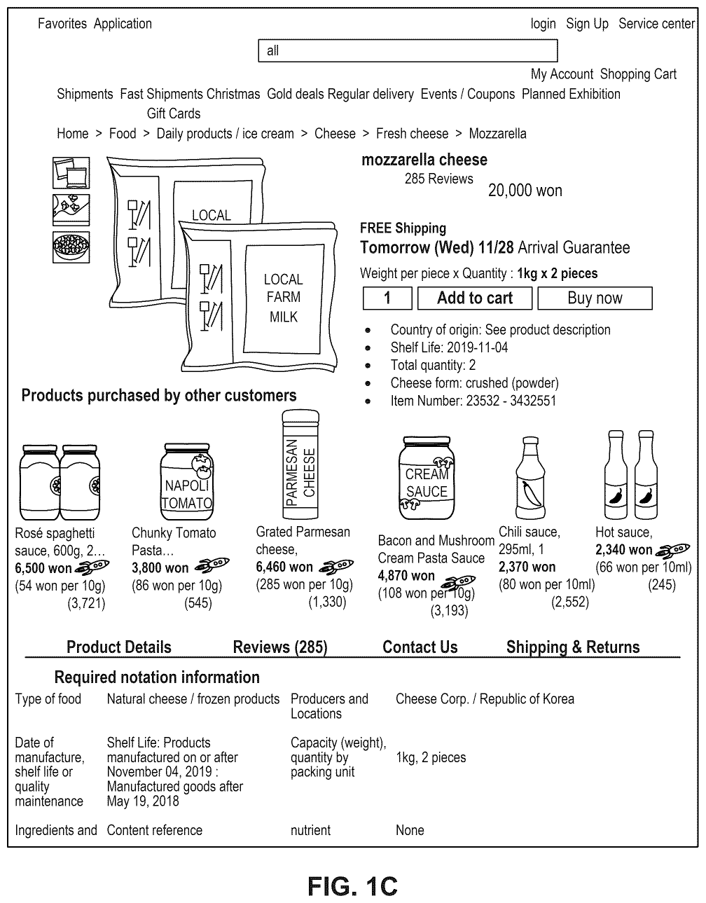

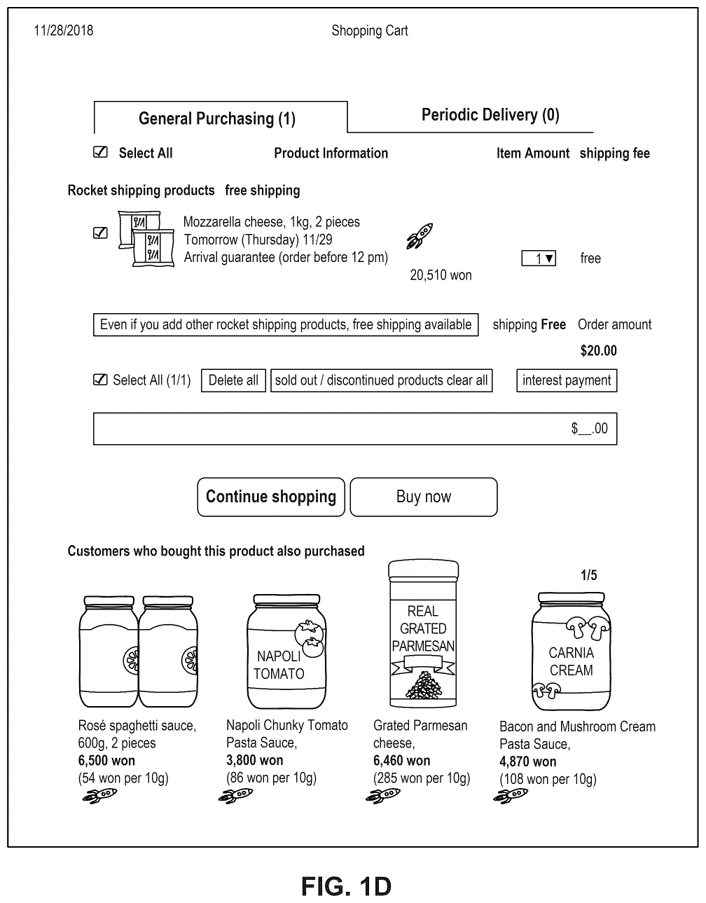

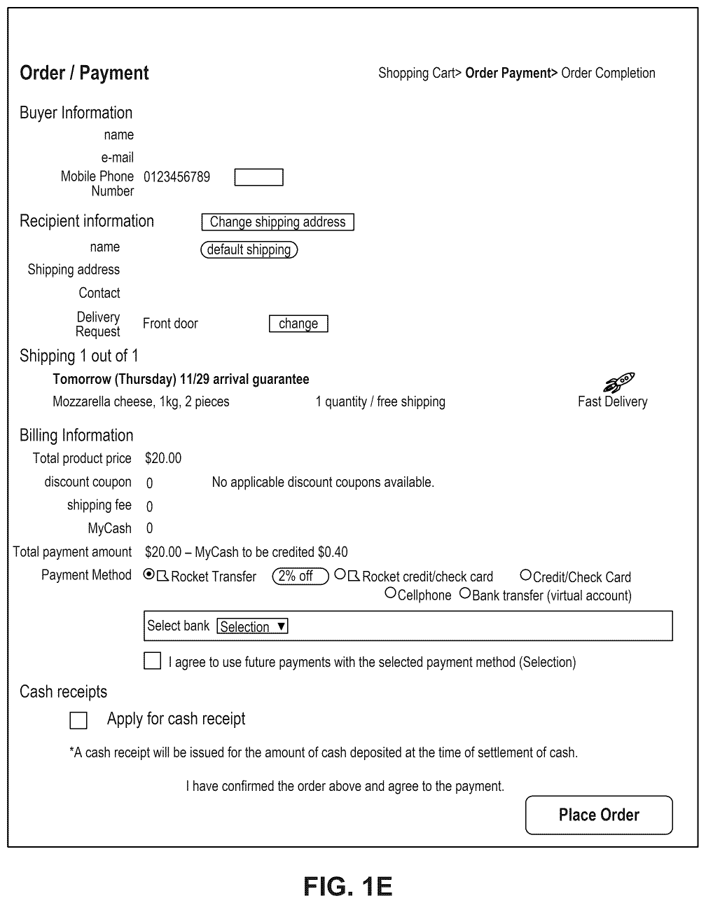

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., “fresh” items such as fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count of products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

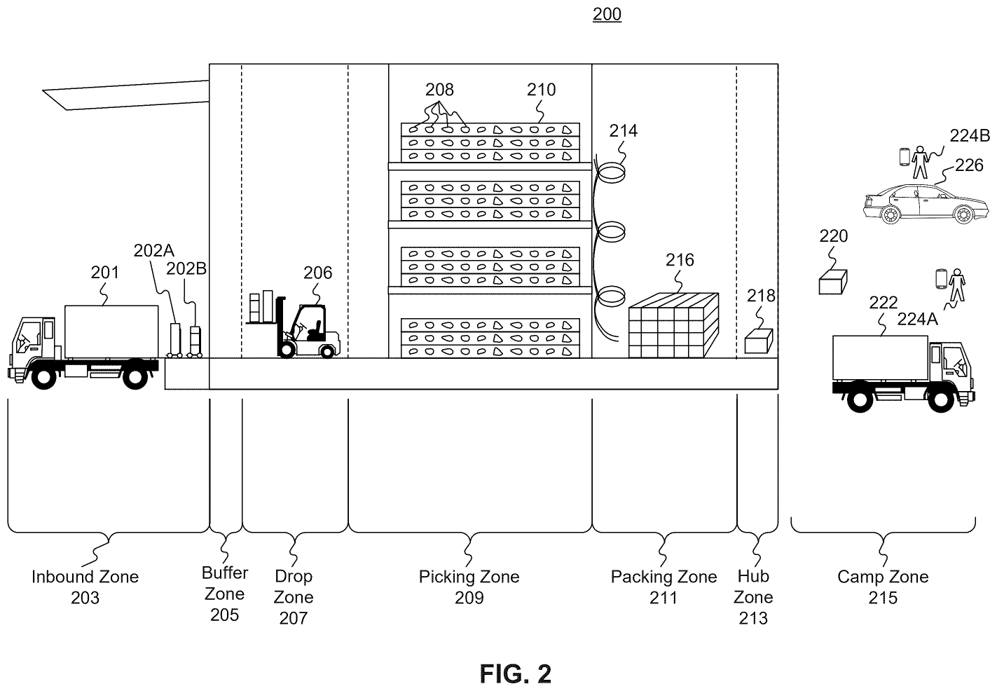

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 119B.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

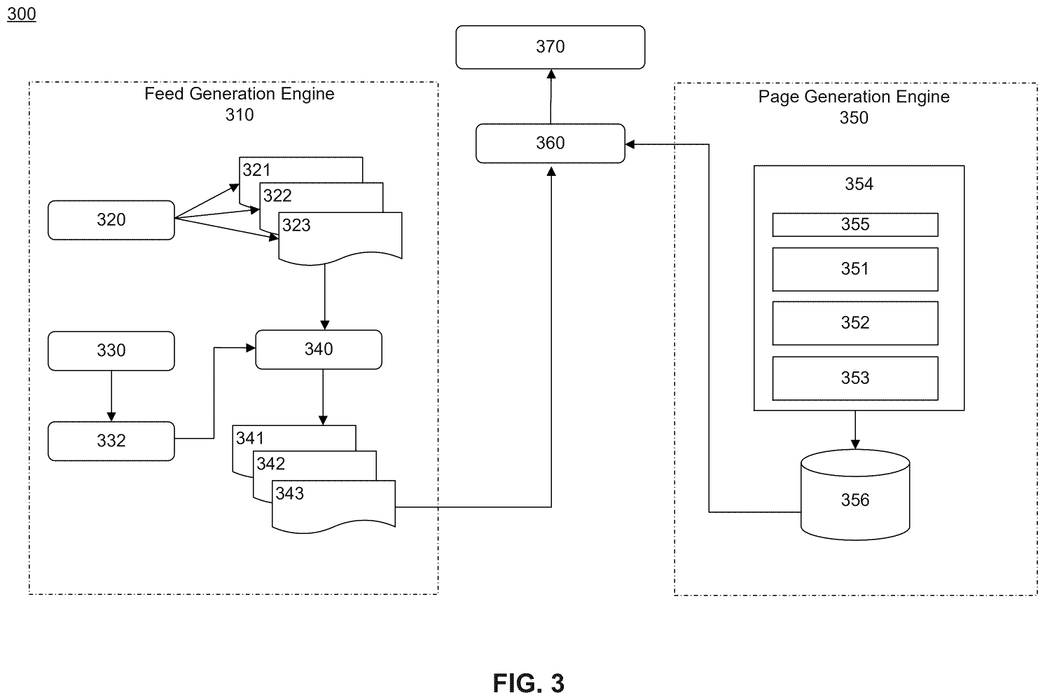

FIG. 3 is a schematic block diagram illustrating an exemplary embodiment of a content management system 300 to generate landing webpages, consistent with the disclosed embodiments.

In some embodiments, content management system 300 may include a feed generation engine 310 and a page generation engine 350. In some embodiments, content management system 300, feed generation engine 310, of page generation engine 350 may be software, computer-implemented systems, devices, etc.

In some embodiments, feed generation engine 310 may include a campaign manager 320 that is configured to generate feed data 321, 322, and 323. In some embodiments, a vendor may use a vendor user device (e.g., mobile devices 119A, 119B, and 119C of FIG. 1A) to interact with campaign manager 320 to generate feed data 321, 322, and 323.

In some embodiments, user devices may be a tablet, mobile device, computer, or the like. User devices may include a display. The display may include, for example, liquid crystal displays (LCD), light emitting diode screens (LED), organic light emitting diode screens (OLED), a touch screen, and other known display devices. The display may show various information to a user. For example, it may display a user interface element, which includes an option vendors to provide configuration data or generate personalized landing webpages as described in the disclosed embodiments. User devices may include one or more input/output (I/O) devices. The I/O devices may include one or more devices that allow an operator to send and receive information from user devices or another device. The I/O devices may include various input/output devices, a camera, a microphone, a keyboard, a mouse-type device, a gesture sensor, an action sensor, a physical button, an oratory input, etc. The I/O devices may also include one or more communication modules (not shown) for sending and receiving information from system 300 by, for example, establishing wired or wireless connectivity between user devices, content management system 300, or components of other systems described in the disclosed embodiments (e.g., components of FIG. 1A).

In some embodiments, content management system 300 may include processors, memories, and a data structure storages.

Processors may be one or more known processing devices, such as a microprocessor from the Pentium™ family manufactured by Intel™ or the Turion™ family manufactured by AMD™. Processors may constitute a single core or multiple core processor that executes parallel processes simultaneously. For example, processors may use logical processors to simultaneously execute and control multiple processes. Processors may implement virtual machine technologies or other known technologies to provide the ability to execute, control, run, manipulate, store, etc. multiple software processes, applications, programs, etc. In another example, processors may include a multiple-core processor arrangement configured to provide parallel processing functionalities to allow WMS 119 to execute multiple processes simultaneously. One of ordinary skill in the art would understand that other types of processor arrangements could be implemented that provide for the capabilities disclosed herein.

Memories may store one or more operating systems that perform known operating system functions when executed by processors. By way of example, the operating system may include Microsoft Windows, Unix, Linux, Android, Mac OS, iOS, or other types of operating systems. Accordingly, examples of the disclosed invention may operate and function with computer systems running any type of operating system. Memories may be a volatile or non-volatile, magnetic, semiconductor, tape, optical, removable, non-removable, or other type of storage device or tangible computer readable medium.

Data structure storages may include, for example, Oracle™ databases, Sybase™ databases, or other relational databases or non-relational databases, such as Hadoop™ sequence files, HBase™, or Cassandra™. Data structure storages may include computing components (e.g., database management system, database server, etc.) configured to receive and process requests for data stored in memory devices of the database(s) and to provide data from the database(s). Data structure storages may include NoSQL databases such as HBase, MongoDB™ or Cassandra™. Alternatively, data structure storages may include relational databases such as Oracle, MySQL and Microsoft SQL Server. In some embodiments, data structure storages may take the form of servers, general purpose computers, mainframe computers, or any combination of these components.

Data structure storages may store data that may be used by processors for performing methods and processes associated with disclosed examples. Data structure storages may be located in content management system 300 as shown in FIG. 3, or alternatively, it may be in external storage devices located outside of content management system 300. Data stored in data structure storages may include any suitable data associated with generating personalized landing webpages.

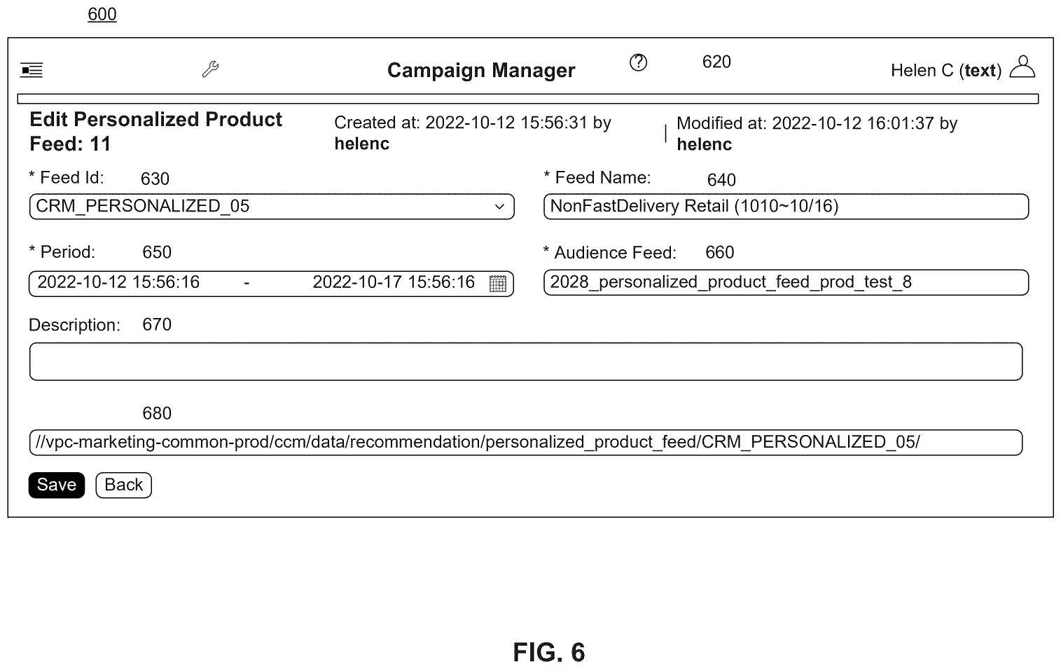

It should be understood that while feed data 321, 322, and 323 are shown, campaign manager 320 may generate less or more feed data (e.g., based on a vendor user using a vendor user device to configure the feed data by user interface 600 of FIG. 6; feed data may include customers who have not purchased fresh products such as milk, vegetables, meat, or the like in a recent time period (e.g., the preceding month) and the generated recommended products may include personalized discounted fresh products for these customers; feed data may include special member customers and the generated recommended products may be personalized discounted daily deals for special products). In some embodiments, each of feed data 321, 322, or 323 may correspond to a specific segment (e.g., group of customers) and a specific product recommendation algorithm.

For example, feed data 321 may correspond to a segment for a holiday and a specific product recommendation algorithm for customers in this segment. Similarly, feed data 322 may correspond to a segment with a discount (e.g., 10%, 20%, 25%, etc.) on product recommendations personalized for the customers in the segment and a specific product recommendation algorithm for customers in this segment. In some embodiments, feed data 323 may correspond to a third specific segment for fresh products (e.g., customers who purchase or tend to purchase products that expire) and a specific product recommendation algorithm for customers in this segment. It should be understood that the disclosed embodiments are not limited to the described segments and may correspond to any number of segments.

In some embodiments, each feed data may include lists of customer identification values and corresponding product identification values associated with the customer identification values. For example, one group of feed data (e.g., feed data 321) may include customer identification value=123456 and corresponding product identification values={900, 874, 327, 594, 4543} and also include customer identification value=54321 and corresponding product identification values={902, 474, 427, 1594, 434}.

In some embodiments, campaign manager 320 may use customer user engagement data (e.g., a customer selecting a user interface icon corresponding to a product, a customer hovering over a user interface icon corresponding to a product, a customer adding a product to a webpage cart, a customer purchasing a product, products that a customer previously viewed, products a customer added to shopping cart, related products from categories associated with products customer has interacted/engaged with, etc.) to determine a specific product recommendation algorithm for each feed data. For example, campaign manager 320 may receive, from at least one customer user device, at least one user engagement, such as one of the above types of “user engagement data,” associated with a plurality of products.

In some embodiments, an icon (e.g., a user interface icon) may comprise one or more of a graphic file, a symbol, text, or any other visual representation of an object or an action (e.g., such as a product for sale, a recommended product for sale, an option to purchase a product, an option to view a product, etc.).

In some embodiments, feed generation engine 310 may include a database 330, which may include data for audience platform 332. For example, database 330 may include data to generate or build the models.

In some embodiments, feed generation engine 310 may include an audience platform 332 that communicates with database 330 to obtain generated models. In some embodiments, a vendor (e.g., a marketer) may use a vendor user device to interact with a user interface of audience platform 332. A vendor may use audience platform 332 to configure the precise customer feed data for generating landing webpages. For example, the precise feed data may include personalized recommended products that are included on a landing webpage for a customer (e.g., during a campaign).

In some embodiments, configuration data from a vendor user device may include at least one model (e.g., a model based on customer user engagement data within the last 1 month, 3 months, 6 months, 9 months, 1 year, etc.; a model based on customers not making a purchase in the last 90 days, 180 days, etc.), at least one targeted customer (e.g., segment identification data, control segment identification data for a control segment of customers, etc.), a time span (e.g., corresponding to user engagement data or a future time span corresponding to a campaign), at least one targeted product category, at least one target product, at least one excluded product category, product category diversity, click-to rate optimization, conversion rate optimization, a number of product recommendations to be included in the generated landing webpage (e.g., a number of widgets to be included in the generated landing webpage), schema identification (e.g., a schema defined in the frontend to collect logs; e.g., each component on a landing webpage has different schema identification so it is known from where impression and clicks are coming), a landing webpage name, an event name (e.g., name of campaign), a number of lookback days (e.g., corresponding to a time span for user engagement data), a guaranteed discount rate for any number of recommended products, a maximum product price for any of the recommended products, an exclude feed identification, promotion management code (e.g., a coupon promotion eligible for a certain campaign), vendor item identification (e.g., a product identification of a product from a vendor; multiple vendors may sell the same product, so each product will have a different vendor item identification, but the same product identification), etc.

In some embodiments, click-to rate optimization may correspond to at least one product of a plurality of products that maximizes customer user engagement with the at least one product. In some embodiments, conversion rate optimization may correspond to at least one product of the plurality of products that maximizes purchasing of the at least one product. In some embodiments, product category diversity may indicate the number of different product categories that are included in the personalized recommended products for a customer (e.g., are recommended products all from the same product category, are recommended products from two or more different categories, etc.).

In some embodiments, feed generation engine 310 may include a coordinator system 340. In some embodiments, coordinator system 340 may receive feed data from campaign manager 320 and receive configuration data for the precise customer feed data from audience platform 332. In some embodiments, feed data from campaign manager 320 may include a threshold time period or corresponding vendor marketing campaign (e.g., a holiday, a discount season, etc.) during which specific landing webpages are generated. In some embodiments, coordinator system 340 may combine the received data to generate personalized product recommendations for the associated customers (e.g., by applying the specific product recommendation algorithm of the configuration data to a plurality of products associated with at least one user engagement). In some embodiments, applying the configuration data to a plurality of products associated with at least one customer user engagement data is based on at least one user engagement by the customer user device within a threshold time period (e.g., model times based on customer user engagement data within the last 1 month, 3 months, 6 months, 9 months, 1 year, etc.; a model based on customers not making a purchase in the last 90 days, 180 days, etc.). In some embodiments, coordinator system 340 may generate a hierarchical data structure of the plurality of products based on the applied configuration data. In some embodiments, coordinator system 340 may determine, using the generated hierarchical data structure, at least one recommended product. For example, coordinator system 340 may determine, using a model of the configuration data, at least one recommended product.

In some embodiments, a specific product recommendation algorithm or model may rank the plurality of products (e.g., several millions of products) for each customer based on a customer's past browsing and purchase history and product attributes (e.g., popularity, average reviews, etc.). Based on the scores, the algorithm or model may determine a top number of product recommendations for each customer.

In some embodiments, the model may be a two-layered model. The first layer may be a natural language processing (NLP) model (e.g., item2vec model) and may generate the candidate pool of products for customers (e.g., it searches for the product pool that customers may be interested in). The second layer may be a gradient boosting classification model, and it may rank the products from the product pool for each customer.

In some embodiments, models may have category-level and product-level rankings. For example, a model may recommend 10 products in the 3 categories with the highest ranking for each customer (e.g., up to 30 products).

In an exemplary model, the following data may be sorted:
Category A: product 1,2,3
Category B: product 1,3,4
Category C: product 1,4

In this example, the model may output:
A-1>B-1>C-1>A-2>B-3>C-4>A-3>B-4

In some embodiments, categories may need to be constrained when selecting a model for a campaign (e.g., back-to-school may constrain to categories related to school such as pencils, classroom items, children's clothes, backpacks, etc.). In some embodiments, models may rank by products and filter by categories.

In some embodiments, models may be updated on a period basis based on certain events (e.g., daily, weekly, etc.) and target customers may be updated on a periodic basis (e.g., daily, weekly, etc.). For example, target customers may be updated such that certain products or types of products are not recommended to customers who have already purchased that product or used a coupon.

In some embodiments, based on the combination, coordinator system 340 may determine at least one recommended product of a plurality of products based on the applied configuration data and generate personalized product recommendation feeds 341, 342, and 343, corresponding to feed data 321, 322, and 323, respectively. In some embodiments, the recommended products may correspond to a top percentile (e.g., top 10%, top 20%, etc.) of products based on the application of the configuration data to the plurality of products associated with the at least one user engagement. In some embodiments, coordinator system 340 may transmit the generated personalized product recommendation feeds 341, 342, and 343 (e.g., the top product recommendations for the corresponding segments) to a display API 360.

In some embodiments, page generation engine 350 may include a database 356 that includes a landing webpage layout data structure (e.g., a webpage layout structure). For example, a landing webpage layout 354 may include a banner 355 and widget zones (e.g., widgets 351, 352, and 353). It should be understood that while only one banner and three widgets are shown, any number of banners or widgets may be used in a landing webpage. In some embodiments, banner 355 may be used to include the corresponding campaign (e.g., a holiday, a discount, a category of products such as fresh products) on the generated landing webpage. In some embodiments, each widget may be used to include the personalized product recommendation on the generated landing webpage. In some embodiments, page generation engine 350 may transmit landing webpage layout 354 to display API 360.

In some embodiments, display API 360 may receive generated personalized product recommendation feeds 341, 342, and 343 from feed generation engine 310 and landing webpage layout 354 from page generation engine 350 in real-time. In some embodiments, display API 360 may generate a personalized landing webpage 370 using the received data. For example, display API 360 may apply the generated personalized product recommendation feeds 341, 342, and 343 to the landing webpage layout 354 such that banner 355 of generated personalized landing webpage 370 incorporates the corresponding campaign data and widgets 351, 352, and 353 of generated personalized landing webpage 370 incorporate the corresponding personalized product recommendation feeds 341, 342, and 343.

For example, display API 360 may receive input from a vendor user device (e.g., included in generated personalized product recommendation feeds 341, 342, and 343) to generate a data structure (e.g., personalized landing webpage 370, which includes landing webpage layout 354). In some embodiments, display API may generate at least one user interface icon and insert each user interface icon may into each of widgets 351, 352, and 353 and each user interface icon may incorporate (e.g., correspond to) personalized product recommendation feeds 341, 342, and 343 (e.g., recommended products). In some embodiments, each recommended product associated with each user interface icon of the generated landing webpage may include a discounted price or associated coupon (e.g., corresponding to a campaign).

In some embodiments, upon a customer user interaction with a user interface icon of personalized landing webpage 370, content management system 300 may generate a SDP (e.g., FIG. 1C) corresponding to at least one recommended product.

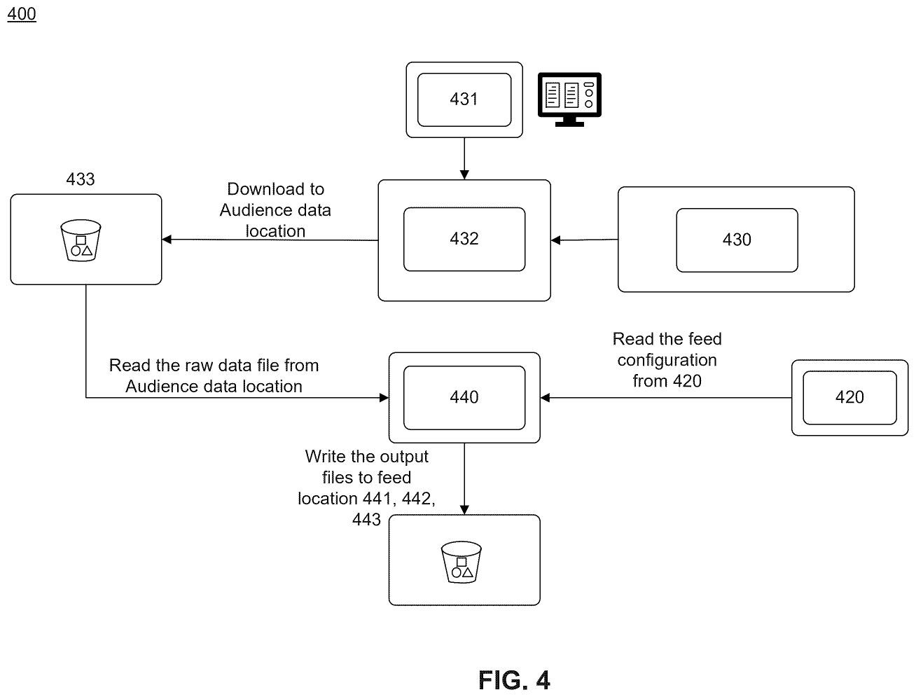

FIG. 4 is a schematic block diagram illustrating an exemplary embodiment of a content management system 400 to generate landing webpages, consistent with the disclosed embodiments.

In some embodiments, content management system 400 may include similar components and operate in a similar manner as described above for content management system 300.

In some embodiments, a feed generation engine (e.g., feed generation engine 310 of FIG. 3) may include a campaign manager 420 that is configured to generate feed data (e.g., feed data 321, 322, and 323 of FIG. 3). In some embodiments, a vendor may use a vendor user device to interact with campaign manager 420 to generate the feed data. In some embodiments, each of the feed data may correspond to a specific segment (e.g., group of customers) and a specific product recommendation algorithm.

In some embodiments, each feed data may include lists of customer identification values and corresponding product identification values associated with the customer identification values. For example, one group of feed data may include customer identification value=123456 and corresponding product identification values={900, 874, 327, 594, 4543} and also include customer identification value=54321 and corresponding product identification values={902, 474, 427, 1594, 434}.

In some embodiments, campaign manager 420 may use customer engagement data (e.g., products that a customer previously viewed, products a customer hovered their cursor over, products a customer added to shopping cart, related products from categories associated with products customer has interacted/engaged with, etc.) to determine a specific product recommendation algorithm for each feed data.

In some embodiments, the feed generation engine may include a database 430, which may include data for an audience platform 432 (e.g., audience platform 332 of FIG. 3). For example, the database may include data to generate or build the models.

In some embodiments, audience platform 432 may communicate with a database to obtain generated models. In some embodiments, a vendor (e.g., a marketer) may interact with an audience user interface 431 on a vendor user device to interact with audience platform 432. A vendor may use audience platform 432 to configure the precise customer feed data for generating landing webpages. For example, the precise feed data may include personalized recommended products that are included on a landing webpage for a customer (e.g., during a campaign).

In some embodiments, the feed generation engine may include a coordinator system 440 (e.g., coordinator system 340 of FIG. 3). In some embodiments, coordinator system 440 may receive feed data from campaign manager 420 and receive configuration data 433 for the precise customer feed data from audience platform 432. In some embodiments, coordinator system 440 may combine the received data to generate personalized product recommendations for the associated customers (e.g., by applying the specific product recommendation algorithm based on the configuration data). Based on the combination, coordinator system 440 may generate personalized product recommendation feeds 441, 442, and 443, corresponding to the feed data. In some embodiments, coordinator system 440 may transmit the generated personalized product recommendation feeds 441, 442, and 443 (e.g., the top product recommendations for the corresponding segments) to a display API (e.g., display API 360 of FIG. 3).

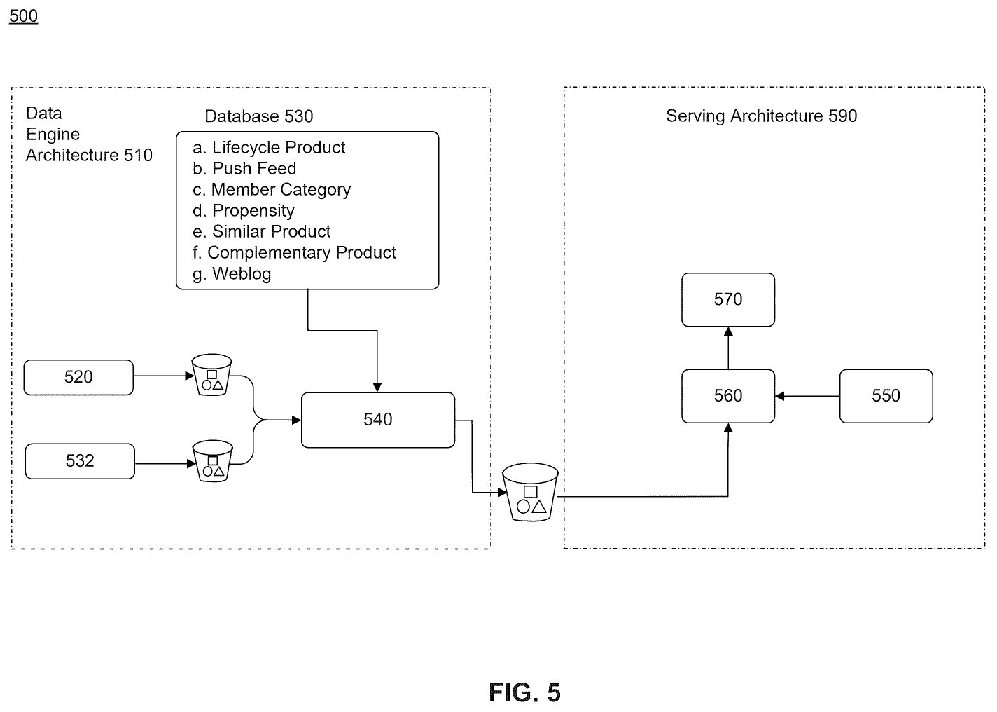

FIG. 5 is a schematic block diagram illustrating an exemplary embodiment of a content management system 500 to generate landing webpages, consistent with the disclosed embodiments.

In some embodiments, a data engine architecture 510 may include a campaign manager 520 (e.g., campaign manager 320 of FIG. 3) that is configured to generate feed data (e.g., feed data 321, 322, and 323 of FIG. 3). In some embodiments, a vendor may use a vendor user device (e.g., mobile devices 119A, 119B, and 119C of FIG. 1A) to interact with campaign manager 520 to generate the feed data.

In some embodiments, campaign manager 520 may generate feed data based on a vendor user using a vendor user device to configure the feed data (e.g., by user interface 600 of FIG. 6). In some embodiments, each of the feed data may correspond to a specific segment (e.g., group of customers) and a specific product recommendation algorithm.

For example, some feed data may correspond to a segment for a holiday and a specific product recommendation algorithm for customers in this segment. In some embodiments, some feed data may correspond to a segment with a discount (e.g., 10%, 20%, 25%, etc.) on product recommendations personalized for the customers in the segment and a specific product recommendation algorithm for customers in this segment. In some embodiments, some feed data may correspond to a third specific segment for fresh products (e.g., customers who purchase or tend to purchase products that expire) and a specific product recommendation algorithm for customers in this segment. It should be understood that the disclosed embodiments are not limited to the described segments and may correspond to any number of segments.

In some embodiments, each feed data may include lists of customer identification values and corresponding product identification values associated with the customer identification values. For example, one group of feed data may include customer identification value=123456 and corresponding product identification values={900, 874, 327, 594, 4543} and also include customer identification value=54321 and corresponding product identification values={902, 474, 427, 1594, 434}.

In some embodiments, campaign manager 520 may use customer user engagement data (e.g., a customer selecting a user interface icon corresponding to a product, a customer hovering over a user interface icon corresponding to a product, a customer adding a product to a webpage cart, a customer purchasing a product, products that a customer previously viewed, products a customer added to shopping cart, related products from categories associated with products customer has interacted/engaged with, etc.) to determine a specific product recommendation algorithm for each feed data. For example, campaign manager 520 may receive, from at least one customer user device, at least one user engagement, such as one of the above types of “user engagement data,” associated with a plurality of products.

In some embodiments, an icon (e.g., a user interface icon) may comprise one or more of a graphic file, a symbol, text, or any other visual representation of an object or an action (e.g., such as a product for sale, a recommended product for sale, an option to purchase a product, an option to view a product, etc.).

In some embodiments, data engine architecture 510 may include a database 530, which may include data to for audience platform 532 via a coordinator system 540 (e.g., coordinator system 340 of FIG. 3). For example, database 530 may include data to generate or build the models. In some embodiments, database 530 may include lifecycle products (e.g., products that customers purchase frequently which include a product's category and average purchased days information); push feed (e.g., all the active products or active products that filter/exclude out of store and blacklist products; these items are recommended via App-Push, e.g., 1 item per person); member category data (e.g., customer propensity data for different categories; data based on customer purchase history); propensity model (e.g., customer's category propensity; likelihood of customer making purchase in the category; similar product model (e.g., items similar to recommended item; e.g., if a recommended item is a running shoe, similar items would be other running shoes); complementary product model (e.g., items different from recommended item; e.g., if a recommended item is a running shoe, then complementary items would be socks, water bottles, etc.); and weblog model (e.g., used to re-rank product; e.g., if today a product has been shown to a customer, the same product will not be shown the next day).

In some embodiments, data engine architecture 510 may include audience platform 532 that communicates with database 530 via coordinator system 540 to obtain generated models. In some embodiments, a vendor (e.g., a marketer) may use a vendor user device to interact with a user interface of audience platform 532. A vendor may use audience platform 532 to configure the precise customer feed data for generating landing webpages. For example, the precise feed data may include personalized recommended products that are included on a landing webpage for a customer (e.g., during a campaign).

In some embodiments, configuration data from a vendor user device may include at least one model (e.g., a model based on customer user engagement data within the last 1 month, 3 months, 6 months, 9 months, 1 year, etc.; a model based on customers not making a purchase in the last 90 days, 180 days, etc.), at least one targeted customer (e.g., segment identification data, control segment identification data for a control segment of customers, etc.), a time span (e.g., corresponding to user engagement data or a future time span corresponding to a campaign), at least one targeted product category, at least one target product, at least one excluded product category, product category diversity, click-to rate optimization, conversion rate optimization, a number of product recommendations to be included in the generated landing webpage (e.g., a number of widgets to be included in the generated landing webpage), schema identification (e.g., a schema defined in the frontend to collect logs; e.g., each component on a landing webpage has different schema identification so it is known from where impression and clicks are coming), a landing webpage name, an event name (e.g., name of campaign), a number of lookback days (e.g., corresponding to a time span for user engagement data), a guaranteed discount rate for any number of recommended products, a maximum product price for any of the recommended products, an exclude feed identification, promotion management code (e.g., a coupon promotion eligible for a certain campaign), vendor item identification (e.g., a product identification of a product from a vendor; multiple vendors may sell the same product, so each product will have a different vendor item identification, but the same product identification), etc.

In some embodiments, click-to rate optimization may correspond to at least one product of a plurality of products that maximizes customer user engagement with the at least one product. In some embodiments, conversion rate optimization may correspond to at least one product of the plurality of products that maximizes purchasing of the at least one product. In some embodiments, product category diversity may indicate the number of different product categories that are included in the personalized recommended products for a customer (e.g., are recommended products all from the same product category, are recommended products from two or more different categories, etc.).

In some embodiments, data engine architecture 510 may include coordinator system 540. In some embodiments, coordinator system 540 may receive feed data from campaign manager 520 and receive configuration data for the precise customer feed data from audience platform 532. In some embodiments, feed data from campaign manager 520 may include a threshold time period or corresponding vendor marketing campaign (e.g., a holiday, a discount season, etc.) during which specific landing webpages are generated. In some embodiments, coordinator system 540 may combine the received data to generate personalized product recommendations for the associated customers (e.g., by applying the specific product recommendation algorithm of the configuration data to a plurality of products associated with at least one user engagement). In some embodiments, applying the configuration data to a plurality of products associated with at least one customer user engagement data is based on at least one user engagement by the customer user device within a threshold time period (e.g., model times based on customer user engagement data within the last 1 month, 3 months, 6 months, 9 months, 1 year, etc.; a model based on customers not making a purchase in the last 90 days, 180 days, etc.). In some embodiments, coordinator system 540 may generate a hierarchical data structure of the plurality of products based on the applied configuration data. In some embodiments, coordinator system 540 may determine, using the generated hierarchical data structure, at least one recommended product. For example, coordinator system 540 may determine, using a model of the configuration data, at least one recommended product.

In some embodiments, a specific product recommendation algorithm or model may rank the plurality of products (e.g., several millions of products) for each customer based on a customer's past browsing and purchase history and product attributes (e.g., popularity, average reviews, etc.). Based on the scores, the algorithm or model may determine a top number of product recommendations for each customer.

In some embodiments, the model may be a two-layered model. The first layer may be a natural language processing (NLP) model (e.g., item2vec model) and may generate the candidate pool of products for customers (e.g., it searches for the product pool that customers may be interested in). The second layer may be a gradient boosting classification model, and it may rank the products from the product pool for each customer.

In some embodiments, models may have category-level and product-level rankings. For example, a model may recommend 10 products in the 3 categories with the highest ranking for each customer (e.g., up to 30 products).

In an exemplary model, the following data may be sorted:
Category A: product 1,2,3
Category B: product 1,3,4
Category C: product 1,4

In this example, the model may output:
A-1>B-1>C-1>A-2>B-3>C-4>A-3>B-4

In some embodiments, categories may need to be constrained when selecting a model for a campaign (e.g., back-to-school may constrain to categories related to school such as pencils, classroom items, children's clothes, backpacks, etc.). In some embodiments, models may rank by products and filter by categories.

In some embodiments, models and data used in models may include lifecycle products (e.g., products that customers purchase frequently which include a product's category and average purchased days information); push feed (e.g., all the active products or active products that filter/exclude out of store and blacklist products; these items are recommended via App-Push, e.g., 1 item per person); member category data (e.g., customer propensity data for different categories; data based on customer purchase history); propensity model (e.g., customer's category propensity; likelihood of customer making purchase in the category; similar product model (e.g., items similar to recommended item; e.g., if a recommended item is a running shoe, similar items would be other running shoes); complementary product model (e.g., items different from recommended item; e.g., if a recommended item is a running shoe, then complementary items would be socks, water bottles, etc.); and weblog model (e.g., used to re-rank product; e.g., if today a product has been shown to a customer, the same product will not be shown the next day).

In some embodiments, models may be updated on a period basis based on certain events (e.g., daily, weekly, etc.) and target customers may be updated on a periodic basis (e.g., daily, weekly, etc.). For example, target customers may be updated such that certain products or types of products are not recommended to customers who have already purchased that product or used a coupon.

In some embodiments, based on the combination, coordinator system 540 may determine at least one recommended product of a plurality of products based on the applied configuration data and generate personalized product recommendation feeds (e.g., personalized product recommendation feeds 341, 342, and 343 of FIG. 3), corresponding to the feed data. In some embodiments, the recommended products may correspond to a top percentile (e.g., top 10%, top 20%, etc.) of products based on the application of the configuration data to the plurality of products associated with the at least one user engagement. In some embodiments, coordinator system 540 may transmit the generated personalized product recommendation feeds (e.g., the top product recommendations for the corresponding segments) to serving architecture 590 in real time.

In some embodiments, serving architecture 590 may include a display API 560 (e.g., display API 360 of FIG. 3) and a page generation engine 550 (e.g., page generation engine 350 of FIG. 3).

In some embodiments, page generation engine 550 may include a database (e.g., database 356 of FIG. 3) that includes a landing webpage layout data structure (e.g., a webpage layout structure). For example, a landing webpage layout (e.g., landing webpage layout 354 of FIG. 3) may include a banner (e.g., banner 355 of FIG. 3) and widget zones (e.g., widgets 351, 352, and 353). In some embodiments, a banner may be used to include the corresponding campaign (e.g., a holiday, a discount, a category of products such as fresh products) on the generated landing webpage. In some embodiments, each widget may be used to include the personalized product recommendation on the generated landing webpage. In some embodiments, page generation engine 550 may transmit a landing webpage layout to display API 560 in real time.

In some embodiments, display API 560 may receive generated personalized product recommendation feeds from data engine architecture 510 and a landing webpage layout from page generation engine 550 in real-time. In some embodiments, display API 560 may generate a personalized landing webpage 570 (e.g., personalized landing webpage 370 of FIG. 3) using the received data. For example, display API 560 may apply the generated personalized product recommendation feeds to the landing webpage layout such that a banner of generated personalized landing webpage 570 incorporates the corresponding campaign data and widgets of generated personalized landing webpage 570 incorporate the corresponding personalized product recommendation feeds.

For example, display API 560 may receive input from a vendor user device (e.g., included in the generated personalized product recommendation feeds) to generate a data structure (e.g., personalized landing webpage 570, which includes a landing webpage layout). In some embodiments, display API 560 may generate at least one user interface icon and insert each user interface icon may into each of the widgets and each user interface icon may incorporate (e.g., correspond to) personalized product recommendation feeds (e.g., recommended products). In some embodiments, each recommended product associated with each user interface icon of the generated landing webpage may include a discounted price or associated coupon (e.g., corresponding to a campaign).

In some embodiments, upon a customer user interaction with a user interface icon of personalized landing webpage 570, content management system 500 may generate an SDP (e.g., FIG. 1C) corresponding to at least one recommended product in real time.

FIG. 6 shows an exemplary user interface 600 of a campaign manager (e.g., campaign manager 320 of FIG. 3, campaign manager 420 of FIG. 4), consistent with the disclosed embodiments.

In some embodiments, vendors may use vendor user devices to interact with user interface 600 to configure the feed data (e.g., feed data 321, 322, or 323 of FIG. 3) that is generated. For example, user interface 600 may include feed identification 630, feed name 640, time period 650, audience feed 660, feed data description 670, and uniform resource identifier (URI) 680 for the configured feed data.

In some embodiments, time period 650 may include a threshold time period or corresponding vendor marketing campaign (e.g., a holiday, a discount season, etc.) during which specific landing webpages are generated.

In some embodiments, audience feed 660 may correspond to a location identifier of where personalized product recommendation feeds (e.g., personalized product recommendation feeds 341, 342, and 343 of FIG. 3) are generated.

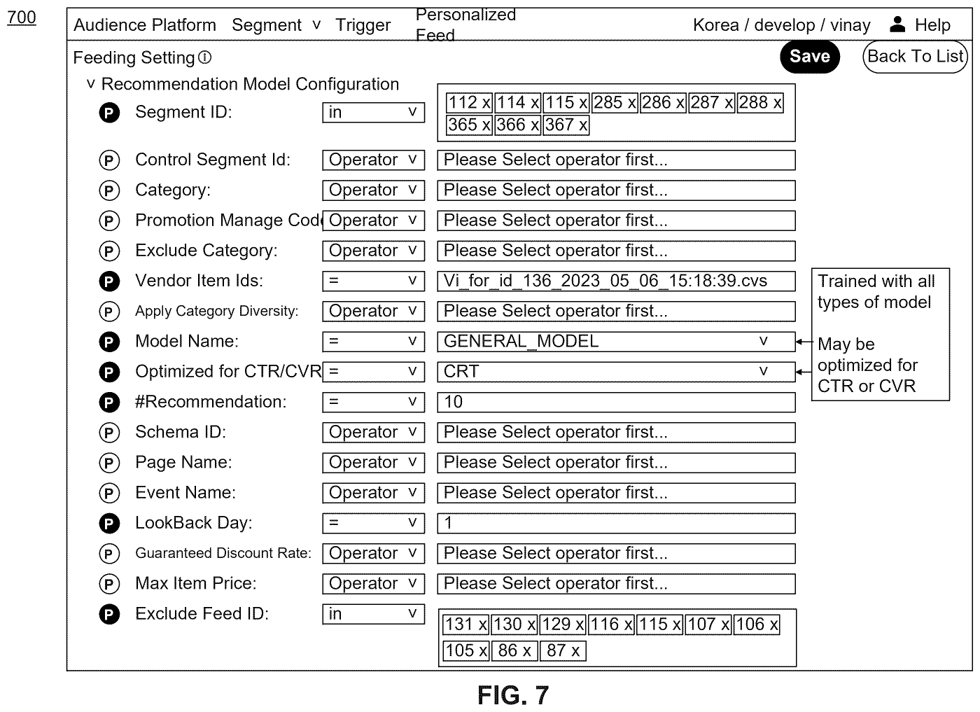

FIG. 7 shows an exemplary user interface 700 of an audience platform (e.g., audience platform 332 of FIG. 3, audience platform 432 of FIG. 4), consistent with the disclosed embodiments.

In some embodiments, the audience platform may communicate with a database (e.g., database 330 of FIG. 3) to obtain generated models. In some embodiments, a vendor (e.g., a marketer) may use a vendor user device to interact with a user interface of the audience platform. A vendor may use the audience platform to configure the precise customer feed data for generating landing webpages. For example, the precise feed data may include personalized recommended products that are included on a landing webpage for a customer (e.g., during a campaign).

In some embodiments, as shown on user interface 700, configuration data from a vendor user device may include segment identification data (e.g., at least one targeted customer, group of customers, etc.), a control segment identification data for a control segment of customers, at least one target product, at least one promotion management code (e.g., a coupon promotion eligible for a certain campaign), at least one excluded product category, at least one vendor item identification (e.g., a product identification of a product from a vendor; multiple vendors may sell the same product, so each product will have a different vendor item identification, but the same product identification), product category diversity, at least one model (e.g., a model based on customer user engagement data within the last 1 month, 3 months, 6 months, 9 months, 1 year, etc.; a model based on customers not making a purchase in the last 90 days, 180 days, etc.), click-to rate optimization, conversion rate optimization, a number of product recommendations to be included in the generated landing webpage (e.g., a number of widgets to be included in the generated landing webpage), schema identification (e.g., a schema defined in the frontend to collect logs; e.g., each component on a landing webpage has different schema identification so it is known from where impression and clicks are coming), a landing webpage name, an event name (e.g., name of campaign), a number of lookback days (e.g., corresponding to a time span for user engagement data), a guaranteed discount rate for any number of recommended products, a maximum product price for any of the recommended products, an exclude feed identification, etc.

In some embodiments, click-to rate optimization may correspond to at least one product of a plurality of products that maximizes customer user engagement with the at least one product. In some embodiments, conversion rate optimization may correspond to at least one product of the plurality of products that maximizes purchasing of the at least one product. In some embodiments, product category diversity may indicate the number of different product categories that are included in the personalized recommended products for a customer (e.g., are recommended products all from the same product category, are recommended products from two or more different categories, etc.). In some embodiments, excluded product category or exclude feed identification may correspond to vendor-selected product categories or products that should be excluded from the recommendations on the generated landing webpages. In some embodiments, a vendor may choose to configure any number of the parameters shown on user interface 700.

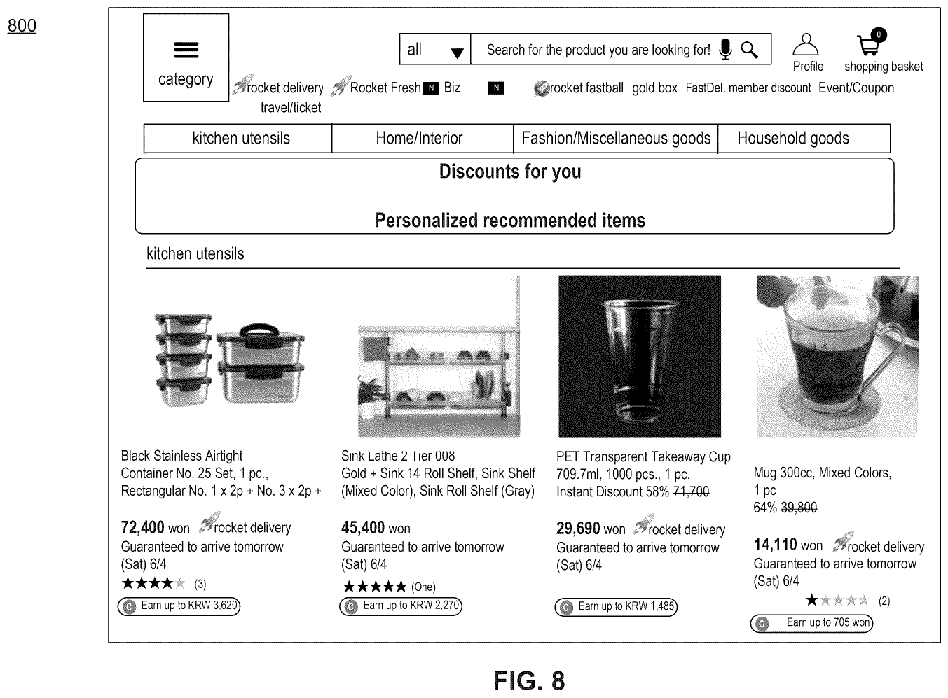

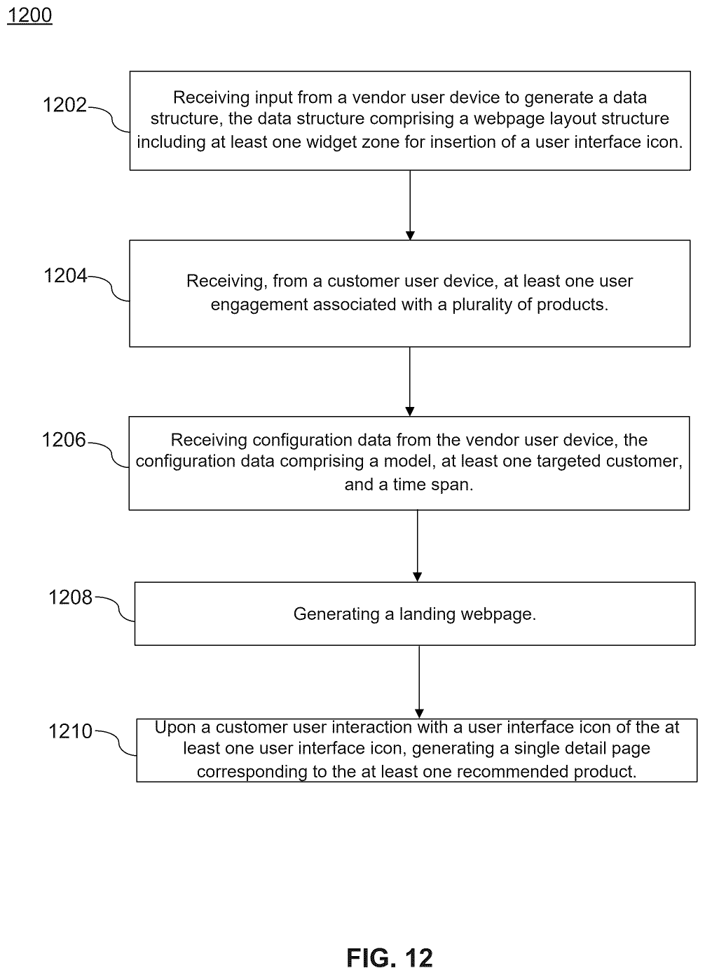

FIG. 8 shows an exemplary personalized landing webpage 800 for a customer, consistent with the disclosed embodiments. For example, personalized landing webpage 800 may include a top category (e.g., kitchen products) with top recommended personalized products in the top category shown, consistent with the disclosed embodiments. In some embodiments, personalized landing webpage 800 may be generated using content management system 300 of FIG. 3, content management system 400 of FIG. 4, process 1200 of FIG. 12, etc.

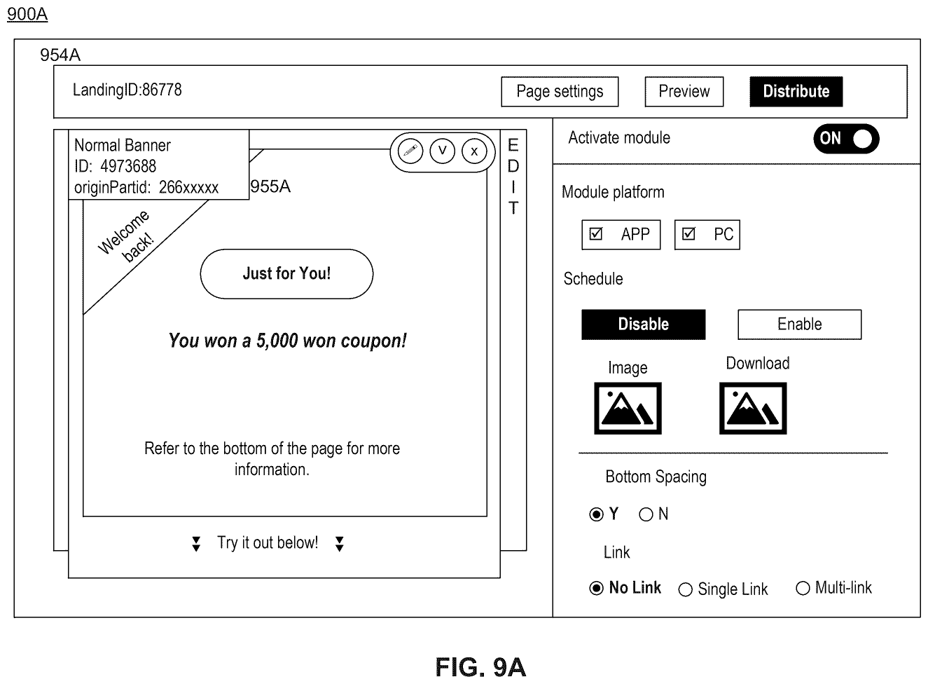

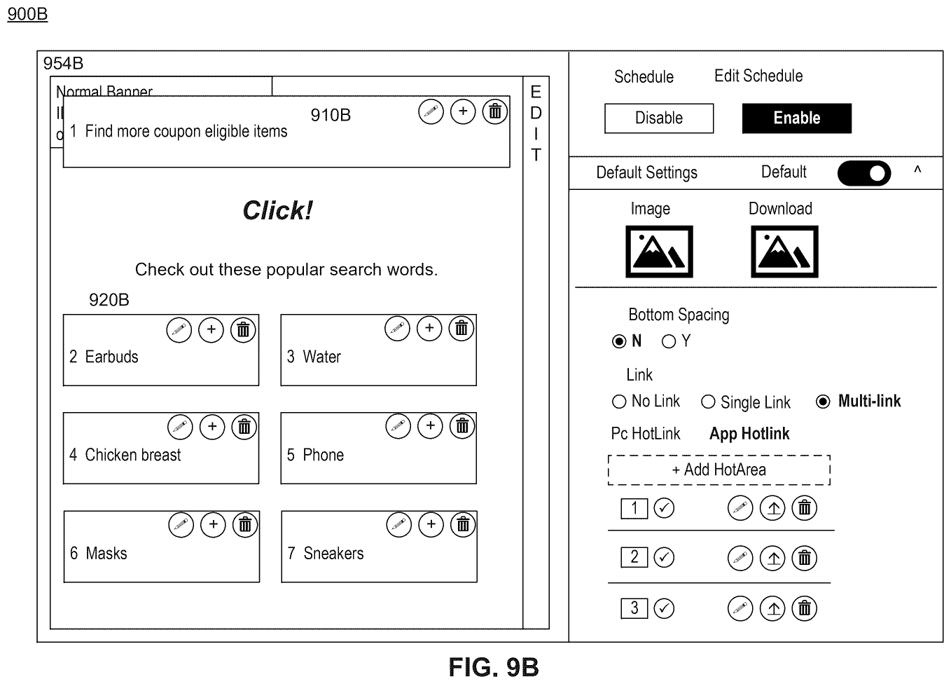

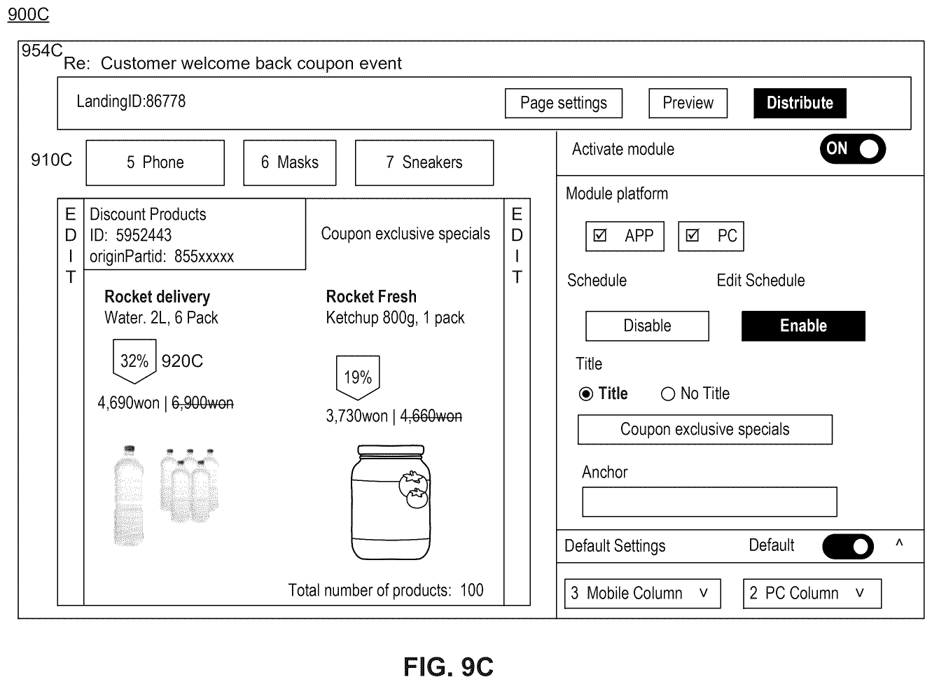

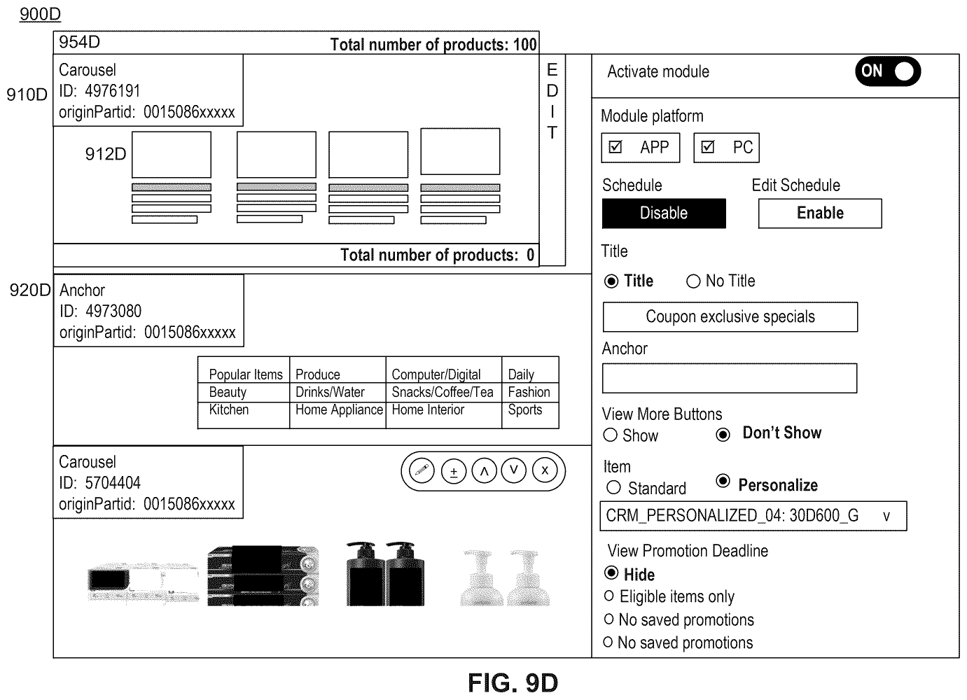

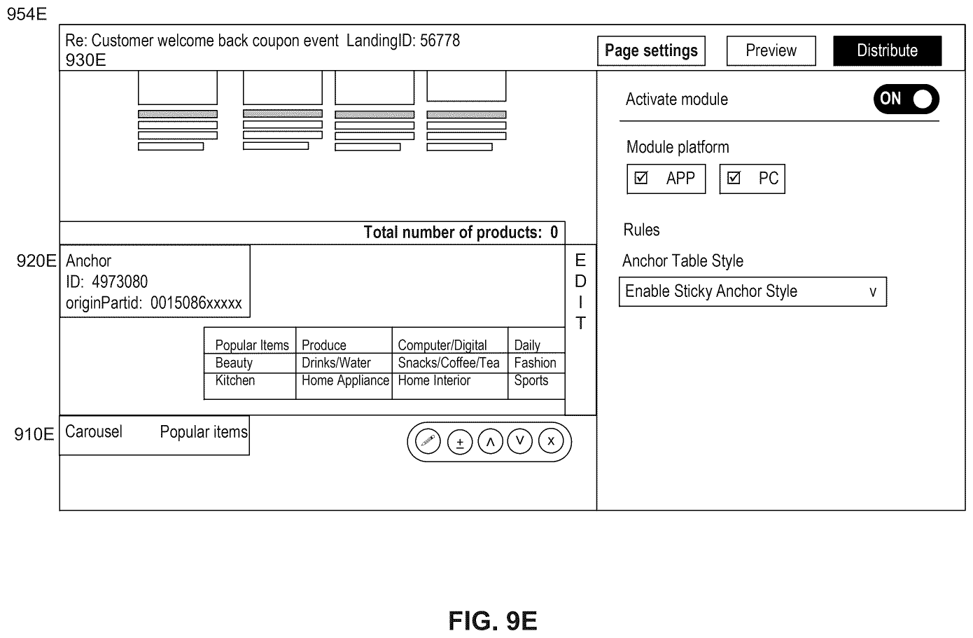

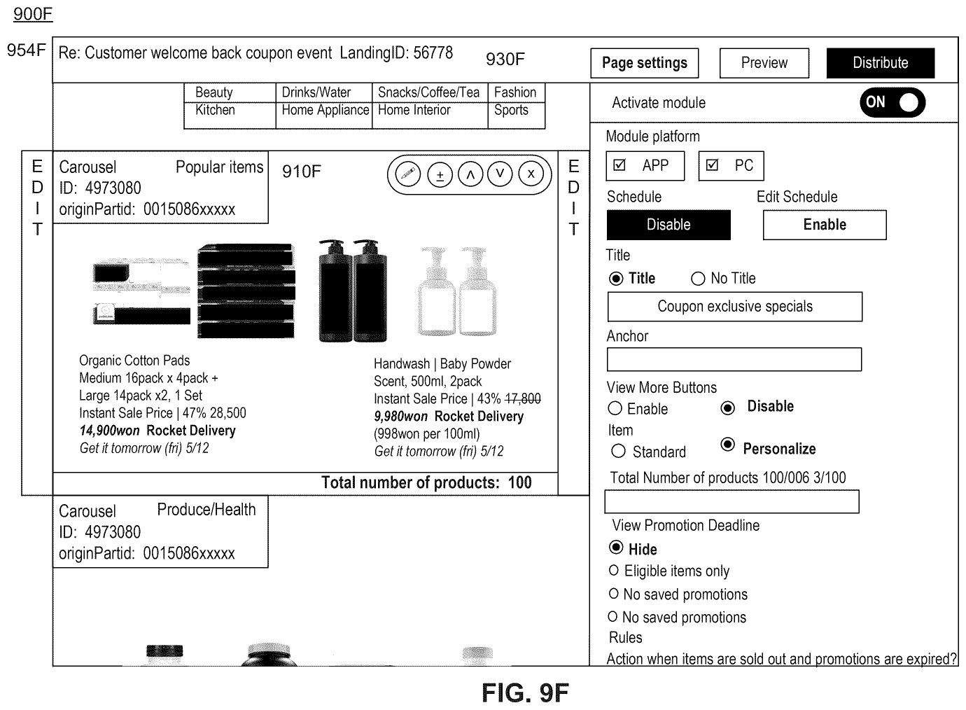

FIGS. 9A-9F show exemplary user interfaces 900A, 900B, 900C, 900D, 900E, and 900F, respectively, for generating personalized landing webpages, consistent with the disclosed embodiments.

FIG. 9A shows an exemplary landing webpage layout 954A (e.g., 354 of FIG. 3) including a banner 955A (e.g., banner 355 of FIG. 3), consistent with the disclosed embodiments. In some embodiments, a vendor may modify landing webpage layout 954A to generate a personalized landing webpage. In some embodiments, a vendor may modify landing webpage layout 954A to include a banner personalized for a segment of customers (e.g., a group of customers may be targeted with a coupon). In some embodiments, a vendor may modify any number of characteristics of landing webpage layout 954A by interacting with various features of user interface 900A (e.g., activating certain modules or banners; enabling or disabling a banner or module; enabling a banner or module for a mobile app or desktop; inserting images, graphics, or URLs for a banner or module; modifying text font of a banner or module; etc.).

FIG. 9B shows an exemplary landing webpage layout 954B (e.g., 354 of FIG. 3) including a search bar 910B and popular search words 920B, consistent with the disclosed embodiments. For example, a vendor may configure landing webpage layout 954B to include search bar 910B for customers such that customers may search for more products eligible for their coupon. A vendor may configure landing webpage layout 954B to include popular search words 920B that may be generated based on the personalized recommended products for a customer. In some embodiments, a vendor may modify any number of characteristics of landing webpage layout 954B by interacting with various features of user interface 900B (e.g., activating certain modules or banners; enabling a banner or module for a mobile app or desktop; enabling or disabling a banner or module; enabling or disabling default settings for a landing webpage; inserting images, graphics, or URLs for a banner or module; modifying text font of a banner or module; etc.).

FIG. 9C shows an exemplary landing webpage layout 954C (e.g., 954C of FIG. 3) including widgets (e.g., widgets 351, 352, and 353 of FIG. 3) with recommended products 910C and price widgets 920C showing discounts for recommended products, consistent with the disclosed embodiments. In some embodiments, a vendor may modify any number of characteristics of landing webpage layout 954C by interacting with various features of user interface 900C (e.g., activating certain modules or banners; enabling a banner or module for a mobile app or desktop; enabling or disabling a banner or module; enabling or disabling default settings for a landing webpage; inserting images, graphics, or URLs for a banner or module; modifying text font of a banner or module; modifying dimensions of layout of landing webpage; etc.).

FIG. 9D shows an exemplary landing webpage layout 954D (e.g., 354 of FIG. 3) including a carousel 910D of widgets 912D (e.g., widgets 351, 352, and 353 of FIG. 3) and an anchor widget 920D with top recommended products, consistent with the disclosed embodiments. In some embodiments, carousel 910D includes a rotation of widgets 912D of recommended products on the generated personalized landing webpage. In some embodiments, a vendor may modify any number of characteristics of landing webpage layout 954D by interacting with various features of user interface 900D (e.g., activating certain modules or banners; enabling a banner or module for a mobile app or desktop; enabling or disabling a banner or module; enabling or disabling default settings for a landing webpage; inserting images, graphics, or URLs for a banner or module; modifying text font of a banner or module; modifying dimensions of layout of landing webpage; hiding certain promotions; hiding certain promotion deadlines; etc.).

FIG. 9E shows an exemplary landing webpage layout 954E (e.g., 354 of FIG. 3) including a carousel 910E of widgets (e.g., widgets 351, 352, and 353 of FIG. 3), an anchor widget 920E with top recommended products, and a banner 930E (e.g., banner 355 of FIG. 3), consistent with the disclosed embodiments. In some embodiments, carousel 910E includes a rotation of widgets of recommended products on the generated personalized landing webpage. In some embodiments, a vendor may modify any number of characteristics of landing webpage layout 954E by interacting with various features of user interface 900E (e.g., activating certain modules or banners; enabling a banner or module for a mobile app or desktop; enabling or disabling a banner or module; enabling or disabling default settings for a landing webpage; inserting images, graphics, or URLs for a banner or module; modifying text font of a banner or module; modifying dimensions of layout of landing webpage; hiding certain promotions; hiding certain promotion deadlines; enabling “sticky” or pinned anchor widgets; etc.).

FIG. 9F shows an exemplary landing webpage layout 954F (e.g., 354 of FIG. 3) including a carousel 910F of widgets (e.g., widgets 351, 352, and 353 of FIG. 3) and a banner 930F (e.g., banner 355 of FIG. 3), consistent with the disclosed embodiments. In some embodiments, carousel 910F includes a rotation of widgets of recommended products on the generated personalized landing webpage. In some embodiments, a vendor may modify any number of characteristics of landing webpage layout 954F by interacting with various features of user interface 900F (e.g., activating certain modules or banners; enabling a banner or module for a mobile app or desktop; enabling or disabling a banner or module; enabling or disabling default settings for a landing webpage; inserting images, graphics, or URLs for a banner or module; modifying text font of a banner or module; modifying dimensions of layout of landing webpage; hiding certain promotions; hiding certain promotion deadlines; enabling “sticky” or pinned anchor widgets; etc.).

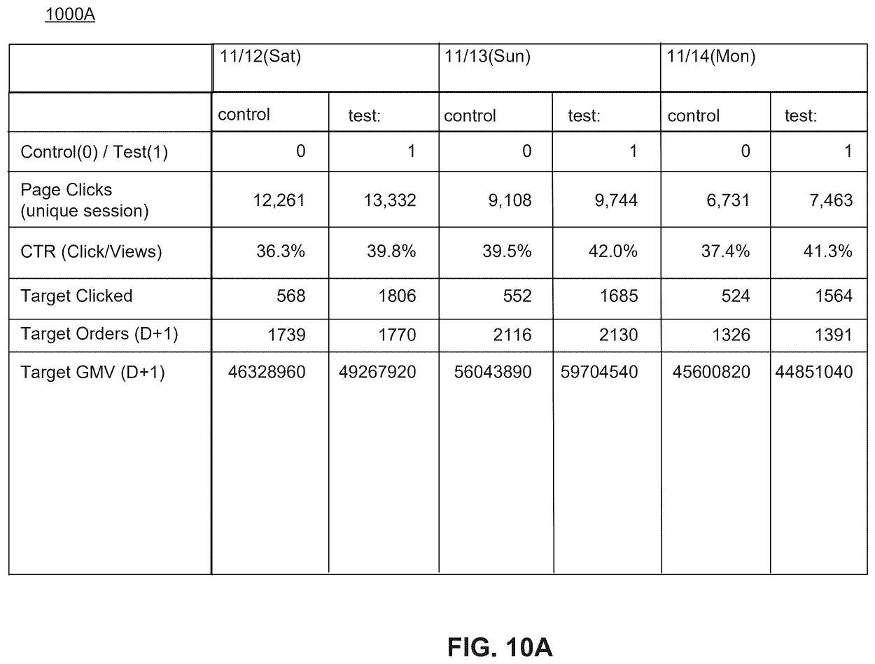

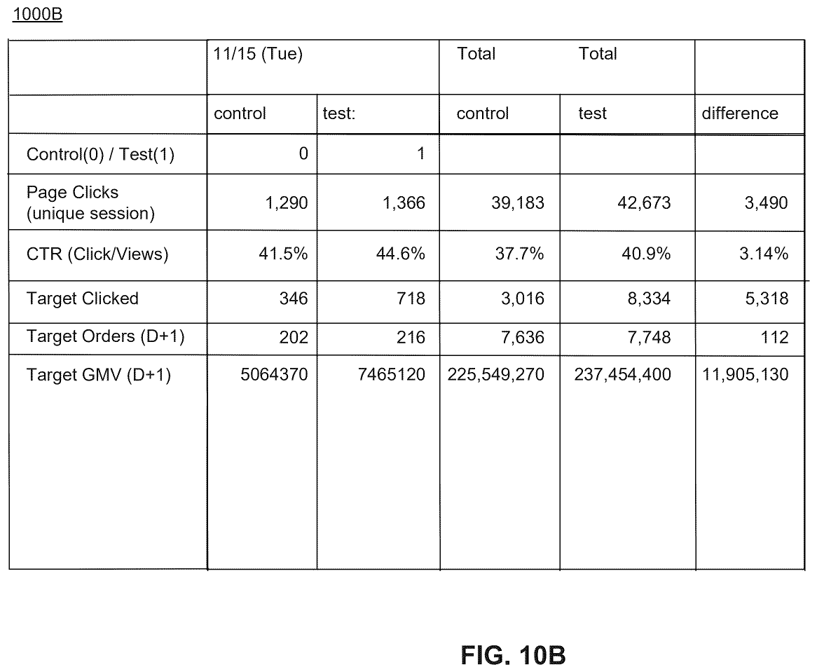

FIGS. 10A and 10B show a comparison between control landing webpages (e.g., “control” landing webpages generated by a typical system) and landing webpages generated as described in disclosed embodiments (e.g., “test” landing webpages), consistent with the disclosed embodiments. FIG. 10A includes chart 1000A and FIG. 10B includes chart 1000B, which is a continuation of chart 1000A. Charts 1000A and 1000B show comparisons spanning an exemplary campaign period (e.g., Saturday November 12 through Tuesday November 15). As shown in charts 1000A and 1000B, compared to landing webpages generated by typical systems, landing webpages of the disclosed embodiments result in an increase in the number of product webpage clicks, click-to rate, target product webpage clicks, target orders, and target gross merchandise value (GMV) (e.g., the total value of merchandise sold over a given period of time). Chart 1000B shows a total difference between control landing webpages and landing webpages of the disclosed embodiments during a campaign. For example, the disclosed embodiments result in 3,490 more landing webpage clicks, a 3.14% increase in click-to rate, 5,318 more target clicks, 112 more target orders, and 11,905,130 more target GMV.

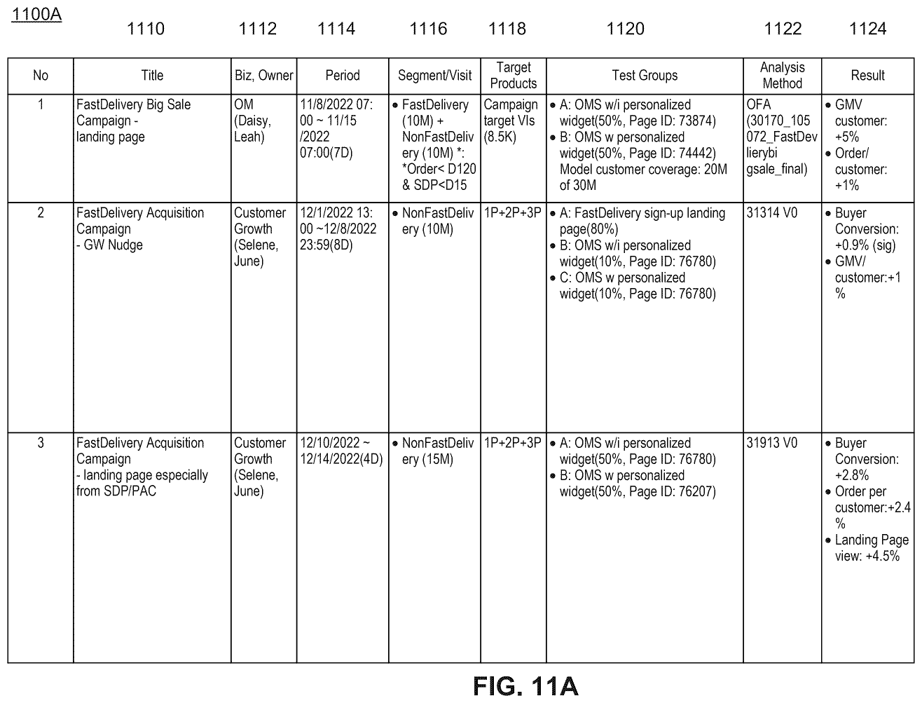

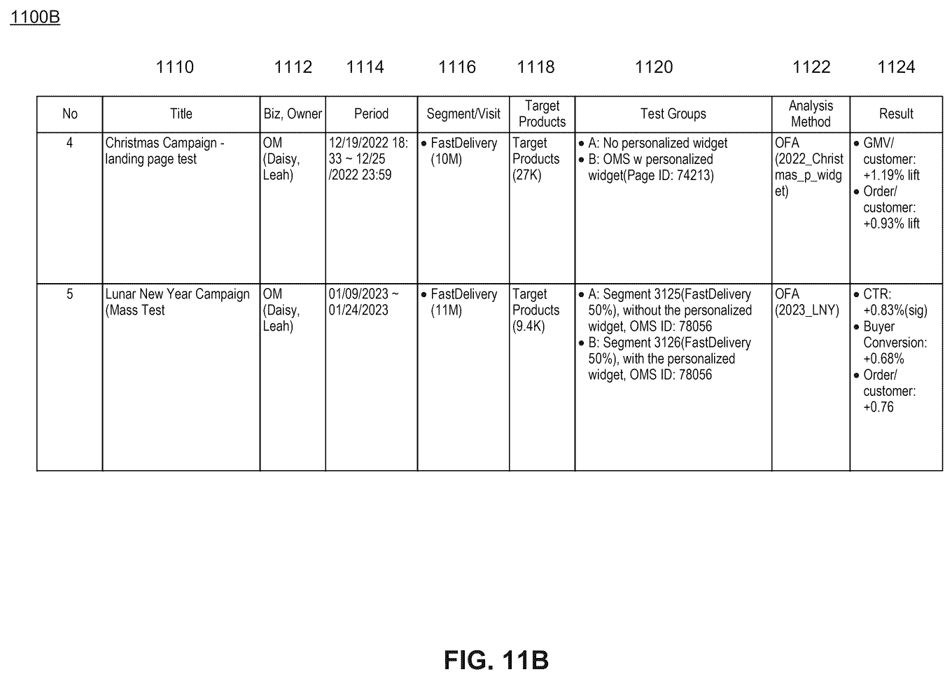

FIGS. 11A and 11B show a comparison between control landing webpages (e.g., “control” landing webpages generated by a typical system) and landing webpages generated as described in disclosed embodiments (e.g., “test” landing webpages), consistent with the disclosed embodiments. Similar to charts 1000A and 1000B of FIGS. 10A and 10B, respectively, FIG. 11A includes chart 1100A and FIG. 11B includes chart 1100B, a continuation of chart 1100A. Charts 1100A and 1100B include column 1110 indicating different campaign names, column 1112 indicating the business or owners (e.g., vendors) of the campaigns, column 1114 indicating the time period for the campaign, column 1116 indicating the customer segment for the campaign, column 1118 indicating the target products of the campaign, column 1120 indicating test groups using the landing webpages of the disclosed embodiments, column 1122 indicating the analysis method using in determining personalized recommended products, and column 1124 indicating results between control landing webpages and the landing webpages of the disclosed embodiments. In some embodiments, column 1124 shows an increase in the number of orders of products by customers, conversion rate, landing webpage views, click-to rate, and GMV (e.g., the total value of merchandise sold over a given period of time). For example, in some campaigns, the disclosed embodiments resulted in an increase in buyer conversion (e.g., conversion of a buyer viewing a product to purchasing the product) of 2.8% compared to existing systems; an increase in orders per customer of 2.4%; an increase in landing webpage views of 4.5%; an increase in click-to rate of 0.83%; and an increase in GMV of 1.19%.

FIG. 12 is a diagram of a process 1200 for generating customizable landing webpages, consistent with the disclosed embodiments.

At step 1202, a system (e.g., content management system 300 of FIG. 3) may be configured to receive input from a vendor user device to generate a data structure, the data structure comprising a webpage layout structure including at least one widget zone for insertion of a user interface icon.

In some exemplary systems, a page generation engine (e.g., page generation engine 350 of FIG. 3) may include a database (e.g., database 356 of FIG. 3) that includes a landing webpage layout data structure (e.g., a webpage layout structure). For example, a landing webpage layout (e.g., landing webpage layout 354 of FIG. 3) may include a banner (e.g., banner 355 of FIG. 3) and widget zones (e.g., widgets 351, 352, and 353 of FIG. 3). It should be understood that while only one banner and three widgets are shown, any number of banners or widgets may be used in a landing webpage. In some embodiments, the banner may be used to include the corresponding campaign (e.g., a holiday, a discount, a category of products such as fresh products) on the generated landing webpage. In some embodiments, each widget may be used to include the personalized product recommendation on the generated landing webpage. In some embodiments, the page generation engine may transmit a landing webpage layout to a display API (e.g., display API 360 of FIG. 3).

In some exemplary systems, the display API may receive input (e.g., included in generated personalized product recommendation feeds 341, 342, and 343 of FIG. 3) from a vendor user device to generate a data structure (e.g., personalized landing webpage 370, which includes landing webpage layout 354 of FIG. 3). In some embodiments, the display API may generate at least one user interface icon and insert each user interface icon may into each of the widgets and each user interface icon may incorporate (e.g., correspond to) personalized product recommendation feeds (e.g., recommended products). In some embodiments, each recommended product associated with each user interface icon of the generated landing webpage may include a discounted price or associated coupon (e.g., corresponding to a campaign).

At step 1204, the system may be configured to receive, from a customer user device, at least one user engagement associated with a plurality of products.

In some exemplary systems, a campaign manager (e.g., campaign manager 320 FIG. 3) may use customer user engagement data (e.g., a customer selecting a user interface icon corresponding to a product, a customer hovering over a user interface icon corresponding to a product, a customer adding a product to a webpage cart, a customer purchasing a product, products that a customer previously viewed, products a customer added to shopping cart, related products from categories associated with products customer has interacted/engaged with, etc.) to determine a specific product recommendation algorithm for each feed data. For example, the campaign manager may receive, from at least one customer user device, at least one user engagement associated with a plurality of products.

In some exemplary systems, the feed generation engine may include a database (e.g., database 330 of FIG. 3), which may include data for an audience platform (e.g., audience platform 332 of FIG. 3). For example, the database may include data to generate or build the models.

At step 1206, the system may be configured to receive configuration data from the vendor user device, the configuration data comprising a model, at least one targeted customer, and a time span.

In some exemplary systems, the feed generation engine may include the audience platform that communicates with the database to obtain generated models. In some embodiments, a vendor (e.g., a marketer) may use a vendor user device to interact with a user interface of the audience platform. A vendor may use the audience platform to configure the precise customer feed data for generating landing webpages. For example, the precise feed data may include personalized recommended products that are included on a landing webpage for a customer (e.g., during a campaign).

In some exemplary systems, configuration data from a vendor user device may include at least one model (e.g., a model based on customer user engagement data within the last 1 month, 3 months, 6 months, 9 months, 1 year, etc.; a model based on customers not making a purchase in the last 90 days, 180 days, etc.), at least one targeted customer (e.g., segment identification data, control segment identification data for a control segment of customers, etc.), a time span (e.g., corresponding to user engagement data or a future time span corresponding to a campaign), at least one targeted product category, at least one target product, at least one excluded product category, product category diversity, click-to rate optimization, conversion rate optimization, a number of product recommendations to be included in the generated landing webpage (e.g., a number of widgets to be included in the generated landing webpage), schema identification (e.g., a schema defined in the frontend to collect logs; e.g., each component on a landing webpage has different schema identification so it is known from where impression and clicks are coming), a landing webpage name, an event name (e.g., name of campaign), a number of lookback days (e.g., corresponding to a time span for user engagement data), a guaranteed discount rate for any number of recommended products, a maximum product price for any of the recommended products, an exclude feed identification, promotion management code (e.g., a coupon promotion eligible for a certain campaign), vendor item identification (e.g., a product identification of a product from a vendor; multiple vendors may sell the same product, so each product will have a different vendor item identification, but the same product identification), schema identification (e.g., a schema defined in the frontend to collect logs; e.g., each component on a landing webpage has different schema identification so it is known from where impression and clicks are coming), etc.

In some exemplary systems, click-to rate optimization may correspond to at least one product of a plurality of products that maximizes customer user engagement with the at least one product. In some embodiments, conversion rate optimization may correspond to at least one product of the plurality of products that maximizes purchasing of the at least one product. In some embodiments, product category diversity may indicate the number of different product categories that are included in the personalized recommended products for a customer (e.g., are recommended products all from the same product category, are recommended products from two or more different categories, etc.).

At step 1208, the system may be configured to generate a landing webpage by generating a webpage using the data structure; applying the configuration data to the plurality of products associated with the at least one user engagement; generating a hierarchical data structure of the plurality of products based on the applied configuration data; determining, using the generated hierarchical data structure, at least one recommended product; generating at least one user interface icon corresponding to the at least one recommended product; inserting the at least one user interface icon into the at least one widget zone of the webpage layout structure.

In some exemplary systems, the feed generation engine may include a coordinator system (e.g., coordinator system 340 of FIG. 3). In some embodiments, the coordinator system may receive feed data from the campaign manager and receive configuration data for the precise customer feed data from the audience platform. In some embodiments, feed data from the campaign manager may include a threshold time period or corresponding vendor marketing campaign (e.g., a holiday, a discount season, etc.) during which specific landing webpages are generated. In some embodiments, the coordinator system may combine the received data to generate personalized product recommendations for the associated customers (e.g., by applying the specific product recommendation algorithm of the configuration data to a plurality of products associated with at least one user engagement). In some embodiments, applying the configuration data to a plurality of products associated with at least one customer user engagement data is based on at least one user engagement by the customer user device within a threshold time period (e.g., model times based on customer user engagement data within the last 1 month, 3 months, 6 months, 9 months, 1 year, etc.; a model based on customers not making a purchase in the last 90 days, 180 days, etc.). In some embodiments, the coordinator system may generate a hierarchical data structure of the plurality of products based on the applied configuration data. In some embodiments, the coordinator system may determine, using the generated hierarchical data structure, at least one recommended product. For example, the coordinator system may determine, using a model of the configuration data, at least one recommended product.

In some exemplary systems, a specific product recommendation algorithm or model may rank the plurality of products (e.g., several millions of products) for each customer based on a customer's past browsing and purchase history and product attributes (e.g., popularity, average reviews, etc.). Based on the scores, the algorithm or model may determine a top number of product recommendations for each customer.

In some exemplary systems, the model may be a two-layered model. The first layer may be a natural language processing (NLP) model (e.g., item2vec model) and may generate the candidate pool of products for customers (e.g., it searches for the product pool that customers may be interested in). The second layer may be a gradient boosting classification model, and it may rank the products from the product pool for each customer.

In some exemplary systems, models may have category-level and product-level rankings. For example, a model may recommend 10 products in the 3 categories with the highest ranking for each customer (e.g., up to 30 products).

In an exemplary model, the following data may be sorted:
Category A: product 1,2,3
Category B: product 1,3,4
Category C: product 1,4

In this example, the model may output:
A-1>B-1>C-1>A-2>B-3>C-4>A-3>B-4

In some exemplary systems, categories may need to be constrained when selecting a model for a campaign (e.g., back-to-school may constrain to categories related to school such as pencils, classroom items, children's clothes, backpacks, etc.). In some embodiments, models may rank by products and filter by categories.

In some exemplary systems, models may be updated on a period basis based on certain events (e.g., daily, weekly, etc.) and target customers may be updated on a periodic basis (e.g., daily, weekly, etc.). For example, target customers may be updated such that certain products or types of products are not recommended to customers who have already purchased that product or used a coupon.

In some exemplary systems, based on the combination, the coordinator system may determine at least one recommended product of a plurality of products based on the applied configuration data and generate personalized product recommendation feeds corresponding to the feed data. In some embodiments, the recommended products may correspond to a top percentile (e.g., top 10%, top 20%, etc.) of products based on the application of the configuration data to the plurality of products associated with the at least one user engagement. In some embodiments, the coordinator system may transmit the generated personalized product recommendation feeds (e.g., the top product recommendations for the corresponding segments) to the display API.

In some exemplary systems, the display API may receive generated personalized product recommendation feeds from the feed generation engine and the landing webpage layout from the page generation engine in real-time. In some embodiments, the display API may generate a personalized landing webpage (e.g., personalized landing webpage 370 of FIG. 3) using the received data. For example, the display API may apply the generated personalized product recommendation feeds to the landing webpage layout such that the banner of the generated personalized landing webpage incorporates the corresponding campaign data and widgets of the generated personalized landing webpage incorporate the corresponding personalized product recommendation feeds.

At step 1210, upon a customer user interaction with a user interface icon of the at least one user interface icon, the system may be configured to generate a SDP corresponding to the at least one recommended product.

In some exemplary systems, upon a customer user interaction with a user interface icon of the personalized landing webpage, the system may generate a SDP (e.g., FIG. 1C) corresponding to at least one recommended product.

It should be understood that various steps of process 1200 may be performed by various components of a system (e.g., components of FIG. 3), and are not limited to the devices or systems described in the descriptions above.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented system for generating customizable landing webpages, the system comprising:
a memory storing instructions; and
at least one processor configured to execute the instructions to:
receive input from a vendor user device to generate a data structure, the data structure comprising a webpage layout structure including at least one widget zone for insertion of a user interface icon;
receive, from a customer user device, at least one user engagement associated with a plurality of products;
receive configuration data from the vendor user device, the configuration data comprising a model, at least one targeted customer, and a time span;
generate a landing webpage by:
generating a webpage using the data structure;
applying the configuration data to the plurality of products associated with the at least one user engagement;
determining at least one recommended product of the plurality of products based on the applied configuration data;
generating at least one user interface icon corresponding to the at least one recommended product; and
inserting the at least one user interface icon into the at least one widget zone of the webpage layout structure; and
upon a customer user interaction with the generated landing webpage, generate a single detail page corresponding to the at least one recommended product.

2. The computer-implemented system of claim 1, wherein the configuration data further comprises at least one of a targeted product category, an excluded product category, product category diversity, click-to rate optimization, or conversion rate optimization.

3. The computer-implemented system of claim 2, wherein the click-to rate optimization corresponds at least one product of the plurality of products that maximizes user engagement with the at least on product.

4. The computer-implemented system of claim 2, wherein the conversion rate optimization corresponds to at least one product of the plurality of products that maximizes purchasing of the at least one product.

5. The computer-implemented system of claim 1, wherein the at least one user engagement comprises any one of selecting a user interface icon corresponding to a product, hovering over a user interface icon corresponding to a product, adding a product to a webpage cart, or purchasing a product.

6. The computer-implemented system of claim 1, wherein applying the configuration data to the plurality of products associated with the at least one user engagement is based on at least one user engagement by the customer user device within a threshold time period.

7. The computer-implemented system of claim 1, wherein the landing webpage is generated based on a threshold time period or corresponding vendor marketing campaign.

8. The computer-implemented system of claim 1, wherein the at least one recommended product corresponds to a top percentile of products based on the application of the configuration data to the plurality of products associated with the at least one user engagement.

9. The computer-implemented system of claim 1, wherein each recommended product associated with each user interface icon of the generated landing webpage comprises a discounted price or associated coupon.

10. A computer-implemented method for generating customizable landing webpages, the method comprising:
receiving input from a vendor user device to generate a data structure, the data structure comprising a webpage layout structure including at least one widget zone for insertion of a user interface icon;
receiving, from a customer user device, at least one user engagement associated with a plurality of products;
receiving configuration data from the vendor user device, the configuration data comprising a model, at least one targeted customer, and a time;
generating a landing webpage by:
generating a webpage using the data structure;
applying the configuration data to the plurality of products associated with the at least one user engagement;
determining at least one recommended product of the plurality of products based on the applied configuration data;
generating at least one user interface icon corresponding to the at least one recommended product; and
inserting the at least one user interface icon into the at least one widget zone of the webpage layout structure; and
upon a customer user interaction with the generated landing webpage, generating a single detail page corresponding to the at least one recommended product.

11. The computer-implemented method of claim 10, wherein the configuration data further comprises at least one of a targeted product category, an excluded product category, product category diversity, click-to rate optimization, or conversion rate optimization.

12. The computer-implemented method of claim 11, wherein the click-to rate optimization corresponds at least one product of the plurality of products that maximizes user engagement with the at least on product.

13. The computer-implemented method of claim 11, wherein the conversion rate optimization corresponds to at least one product of the plurality of products that maximizes purchasing of the at least one product.

14. The computer-implemented method of claim 10, wherein the at least one user engagement comprises any one of selecting a user interface icon corresponding to a product, hovering over a user interface icon corresponding to a product, adding a product to a webpage cart, or purchasing a product.

15. The computer-implemented method of claim 10, wherein applying the configuration data to the plurality of products associated with the at least one user engagement is based on at least one user engagement by the customer user device within a threshold time period.

16. The computer-implemented method of claim 10, wherein the landing webpage is generated based on a threshold time period or corresponding vendor marketing campaign.

17. The computer-implemented method of claim 10, wherein the at least one recommended product corresponds to a top percentile of products based on the application of the configuration data to the plurality of products associated with the at least one user engagement.

18. The computer-implemented method of claim 10, wherein each recommended product associated with each user interface icon of the generated landing webpage comprises a discounted price or associated coupon.

19. A computer-implemented system for generating customizable landing webpages, the system comprising:
a memory storing instructions; and
at least one processor configured to execute the instructions to:
receive input from a vendor user device to generate a data structure, the data structure comprising a webpage layout structure including at least one widget zone for insertion of a user interface icon;
receive, from a customer user device, at least one user engagement associated with a plurality of products;
receive configuration data from the vendor user device, the configuration data comprising a model, at least one targeted customer, and a time span;
generate a landing webpage by:
generating a webpage using the data structure;
applying the configuration data to the plurality of products associated with the at least one user engagement;
generating a hierarchical data structure of the plurality of products based on the applied configuration data;
determining, using the generated hierarchical data structure, at least one recommended product;
generating at least one user interface icon corresponding to the at least one recommended product; and
inserting the at least one user interface icon into the at least one widget zone of the webpage layout structure; and
upon a customer user interaction with the generated landing webpage, generate a single detail page corresponding to the at least one recommended product.

20. The computer-implemented system of claim 19, wherein determining the at least one recommended product comprises using the model of the configuration data.
